(19) United States
(12) Patent Application Publication
(10) Pub. No.: US 2025/0008339 A1
(43) Pub. Date: Jan. 2, 2025

(54) INFORMATION PROCESSING DEVICE, COMMUNICATION DEVICE, INFORMATION PROCESSING METHOD, COMMUNICATION METHOD, AND COMMUNICATION SYSTEM

(71) Applicant: SONY GROUP CORPORATION, TOKYO (JP)

(72) Inventors: HIROAKI TAKANO, TOKYO (JP); HIROTO KURIKI, TOKYO (JP); HIROFUMI KASAI, TOKYO (JP); TOMOAKI MATSUMURA, TOKYO (JP)

(21) Appl. No.: 18/576,393

(22) PCT Filed: Mar. 14, 2022
(86) PCT No.: PCT/JP2022/011195

§ 371 Date: Jan. 4, 2024

(30) Foreign Application Priority Data
Jul. 19, 2021 (JP) 2021-118404

(51) Int. Cl. H04W 16/16; H04W 48/16

(52) U.S. Cl. CPC H04W 16/16; H04W 48/16

(57) ABSTRACT

An information processing device includes at least one network function among network functions disposed in each of two non-public cellular closed networks connected to each other by secure communication. The network function acquires information related to a communication device connected to the non-public cellular closed network of an own side or a counterpart side, and perform, based on the acquired information, processing related to packet arrival from the communication device connected to one of the two non-public cellular closed networks to the communication device connected to the other of the two non-public cellular closed networks.

### FIELD

The present disclosure relates to an information processing device, a communication device, an information processing method, a communication method, and a communication system.

### BACKGROUND

In recent years, a private network using cellular wireless communication has attracted attention. It is possible, in a conventional private network, to communicate with not only communication devices in the private network but also communication devices outside the private network (for example, a communication device in another private network).

### CITATION LIST

### Non Patent Literature

Non Patent Literature 1: ZTE Corporation, “Consideration on NPN solution”, R3-193624, 3GPP TSG RAN WG3 NR #105, 26-30 Aug. 2019

### SUMMARY

### Technical Problem

However, in a case where communication is performed between different private networks, a communication device communicates with a communication device on a counterpart side via the public network, making it difficult to maintain high security. In addition, forwarding the information of an IP address of one communication device to another private network outside a certain private network leads to leakage of personal information, and thus, it is necessary to take measures.

In view of this, the present disclosure proposes an information processing device, a communication device, an information processing method, a communication method, and a communication system capable of achieving high-security communication between private networks.

Note that the above problem or target is merely one of a plurality of problems or targets that can be solved or achieved by a plurality of embodiments disclosed in the present specification.

### Solution to Problem

In order to solve the above problem, an information processing device according to one embodiment of the present disclosure includes at least one network function among network functions disposed in each of two non-public cellular closed networks connected to each other by secure communication, wherein the network function acquires information related to a communication device connected to the non-public cellular closed network of an own side or a counterpart side, and perform, based on the acquired information, processing related to packet arrival from the communication device connected to one of the two non-public cellular closed networks to the communication device connected to the other of the two non-public cellular closed networks.

### BRIEF DESCRIPTION OF DRAWINGS

FIG. 1 is a diagram illustrating an example of a private network.

FIG. 2 is a diagram illustrating a communication system in a case where there is one 4G/5G private network of a counterpart.

FIG. 3 is a diagram illustrating a communication system in a case where there is a plurality of 4G/5G private networks of a counterpart.

FIG. 4 is a diagram illustrating a state in which RAMNF is arranged in each of a plurality of 4G/5G private networks.

FIG. 5 is a diagram illustrating a configuration example of a communication system according to an embodiment of the present disclosure.

FIG. 6 is a diagram illustrating a configuration example of a management device according to the embodiment of the present disclosure.

FIG. 7 is a diagram illustrating a configuration example of a base station according to the embodiment of the present disclosure.

FIG. 8 is a diagram illustrating a configuration example of a terminal device according to the embodiment of the present disclosure.

FIG. 9 is a diagram illustrating an example of 5G architecture.

FIG. 10 is a diagram illustrating an example of a 4G architecture.

FIG. 11 is a diagram illustrating a state in which a plurality of 4G/5G private networks are linked with each other.

FIG. 12 is a sequence diagram illustrating a procedure of creating a pair of 4G/5G private networks.

FIG. 13 is a diagram illustrating Method 1-1.

FIG. 14 is a diagram illustrating Method 1-2.

FIG. 15 is a sequence diagram illustrating a procedure of Method 1-1.

FIG. 16 is a diagram illustrating Method 2-1.

FIG. 17 is a sequence diagram illustrating a procedure of Method 2-1.

FIG. 18 is a diagram illustrating Method 2-2.

FIG. 19 is a sequence diagram illustrating a procedure of Method 2-2.

FIG. 20 is a sequence diagram in which the procedure of Method 3 is added to the procedure of Method 2-2 as a base.

FIG. 21 is a diagram illustrating a period in which packet transmission is permitted.

FIG. 22 is a sequence diagram illustrating a procedure of Method 4.

FIG. 23 is a diagram illustrating Method 1-3.

### DESCRIPTION OF EMBODIMENTS

Embodiments of the present disclosure will be described below in detail with reference to the drawings. Note that, in each of the following embodiments, the same parts are denoted by the same reference symbols, and a repetitive description thereof will be omitted.

Moreover, in the present specification and the drawings, a plurality of components having substantially the same functional configuration will be distinguished by attaching different numbers after the same reference numerals. For example, a plurality of configurations having substantially the same functional configuration are distinguished as necessary, such as terminal devices 301, 302, and 303. However, when it is not particularly necessary to distinguish between the plurality of components having substantially the same functional configuration, only the same reference numeral is given. For example, in a case where it is not necessary to particularly distinguish the terminal devices 301, 302, and 303, they are simply referred to as the terminal device 30.

One or more embodiments (including examples and modifications) described below can each be implemented independently. On the other hand, at least some of the plurality of embodiments described below may be appropriately combined with at least some of other embodiments. The plurality of embodiments may include novel features different from each other. Accordingly, the plurality of embodiments can contribute to achieving or solving different objects or problems, and can exhibit different effects.

Note that the description will be provided in the following order.

The present disclosure will be described in the following order.
1. Overview
1-1. Local 5G/private 5G
1-2. Features of 4G/5G private network
1-3. Linkage of plurality of private networks
1-4. RAMNF
2. Configuration of Communication System
2-1. Overall configuration of communication system
2-2. Configuration of management device
2-3. Configuration of base station
2-4. Configuration of terminal device
3. Network Architecture
3-1. Configuration example of 5G network architecture
3-2. Configuration example of 4G network architecture
4. Basic Operation of Communication System 1
4-1. Method of linking private networks
4-2. Procedure of creating a pair of private networks
4-3. ID for specifying communication counterpart
5. Detailed Operation of Communication System
5-1. Method 1
5-2. Method 2
6. Other Operations of Communication System 1
6-1. Method 3
6-2. Method 4
6-3. Method 1-3
7. Modification
8. Conclusion

### 1. Overview

In recent years, private networks such as a local 5G and a private 5G have attracted attention. The private network is also referred to as a non-public network.

### <1-1. Local 5G/Private 5G>

The local 5G and the private 5G are implementation of cellular communication services in a limited area such as a factory, an office, a studio, in a hospital, or in a university. Limiting the cellular service to a local area leads to an advantageous effect of being able to provide customized cellular services. In the present embodiment, private 5G and local 5G are referred to as 4G/5G private networks. Many use cases place an importance on security. For example, cases of factories include a case of handling highly confidential technologies, such as a production line in a factory. Facilities such as hospitals are also included in highly confidential use cases due to handling of personal information related to privacy of patients. Universities and business offices handle personal information in many cases, and thus need to maintain high confidentiality in communication related to personal information.

### <1-2. Features of 4G/5G Private Network>

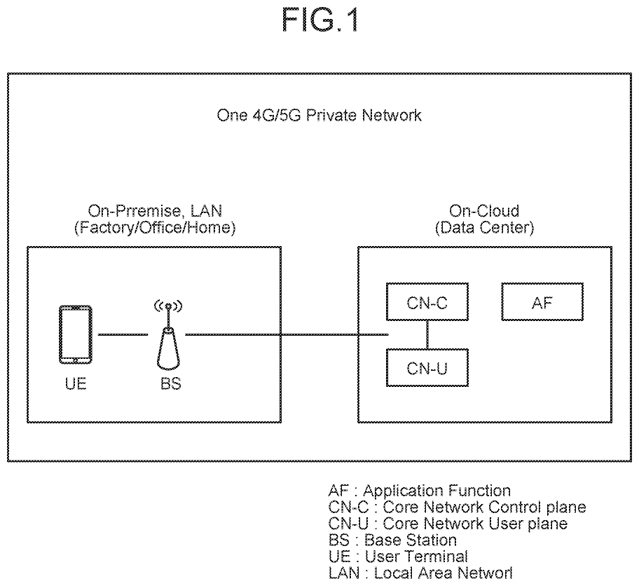

Before describing an overview of the present embodiment, features of a private network will be described. FIG. 1 is a diagram illustrating an example of a private network.

### (1) Characteristics of Closed Network

In a private network, a LAN and a cloud are connected in a closed network. An example of the closed network is a virtual private network (VPN). In a closed network, a base station disposed in a LAN and a core network disposed in a cloud are connected to each other using a private IP address without using a public IP address. Communication performed only in a closed network is resistant to interceptions such as eavesdropping from the outside. It is also possible to have a configuration in which all access from the outside of the closed network is to be blocked, or a packet is transmitted from the inside to the outside of the closed network and only the response to the packet is to be allowed to enter the closed network. In general, it is not possible to access a device or a terminal device in a closed network by applying a trigger from the outside of the closed network, and thus, the closed network is considered to be able to maintain high confidentiality.

There is no need to perform translation between a private IP address and a global IP address, making it possible to facilitate the use of User Datagram Protocol (UDP) communication. In a case where translation is required, a Transmission Control Protocol (TCP) is usually used. Therefore, the feature of facilitated UDP communication is attractive for an application using UDP communication. The communication using UDP has an advantage of low latency.

### (2) IP Address Assigned to Terminal Device

When the terminal device attaches to the network, an IP address is assigned from the core network to the terminal device. Usually, a private IP address is assigned. In the case of a public network, there is a case of directly assigning a public IP address to the terminal device. However, in a 4G/5G private network which is a non-public network, a private IP address is typically assigned to the terminal device. Accordingly, when performing outgoing communication from the closed network, Network Address Translation (NAT translation) is performed to translate the private IP address into the public IP address.

Information as to which IP address has been assigned to the terminal device can be acquired from the core network. 5G has an application program interface (API) named Service Based Interface (SBI) used in acquisition of an IP address of a terminal device. Even in 4G, the IP address of the terminal device can be acquired similarly to 5G when having access to a subscriber file storing the IP address of each terminal device.

By holding the IP address of the terminal device in the closed network, it is possible to perform direct transmission of an IP packet to the terminal device from an application function (AF) side (that is, network initiated message push). Hereinafter, this network function will be provisionally referred to as a Reachability Management Network Function (RAMNF). The network function may be referred to as another function name, not limited to RAMNF. RAMNF will be described in detail below.

### <1-3. Linkage of Plurality of Private Networks>

The present embodiment assumes communication between different private networks. For example, a case of connecting a plurality of 4G/5G private networks over the Internet will be assumed. In this case, since a packet is once sent out to the public Internet, a security threat increases. For security reasons, it is not desirable to directly transmit the IP address of the terminal device to a counterpart side. In addition, since a private IP address is translated into a public IP address once when the packet is sent out to the Internet, there is a problem of passage over the Network Address Translation (NAT). This makes it difficult to perform direct UDP communication.

Note that, in a normal cellular system, when a packet is transmitted to a terminal device by designating an IP address from outside the cellular network, the packet might be or might not be directly delivered to the device. In a limited case where a network service provider has a lot of global IP addresses, once the global IP address is directly assigned to the terminal device, it is practically possible to directly send a packet to the global IP address from the outside. However, feasibility of this depends on a security policy. Permitting the direct delivery of a packet would lead to the risk of entry of undesired traffic from the outside, and therefore such delivery of the packet is not permitted in most cases. That is, taking a countermeasure against this entry of this packet due to its high security threat might lower the degree of freedom in some cases. For security reasons, it is not desirable to directly transmit the IP address of the terminal device to a counterpart side. In the case of cellular network, there is also a problem that the cost of the cellular network is higher than that of the 4G/5G private network. In view of these, it will be important in the future to prepare a plurality of 4G/5G private networks and directly connect these private networks through a VPN tunnel.

Accordingly, hereinafter, a case where different private networks are connected to each other via a VPN tunnel will be discussed.

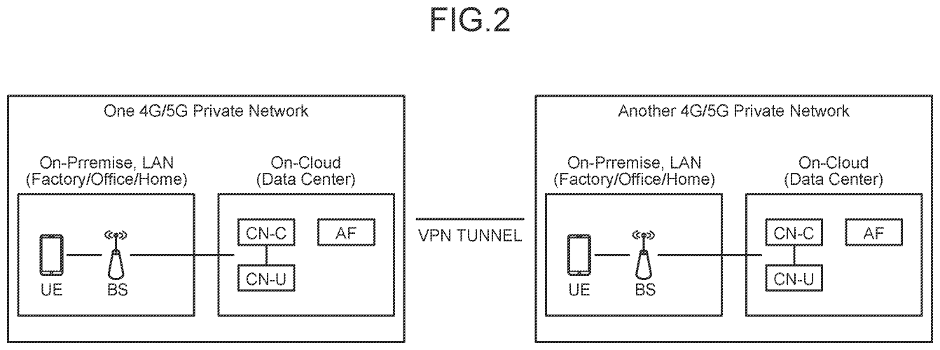

FIG. 2 is a diagram illustrating a communication system in a case where there is one 4G/5G private network of a counterpart. In the example of FIG. 2, two 4G/5G private networks are directly connected by VPN tunneling. Since the closed networks are connected to each other, it is possible, within the closed networks, to send a packet to a terminal device or a client application on the counterpart side by using the private IP address.

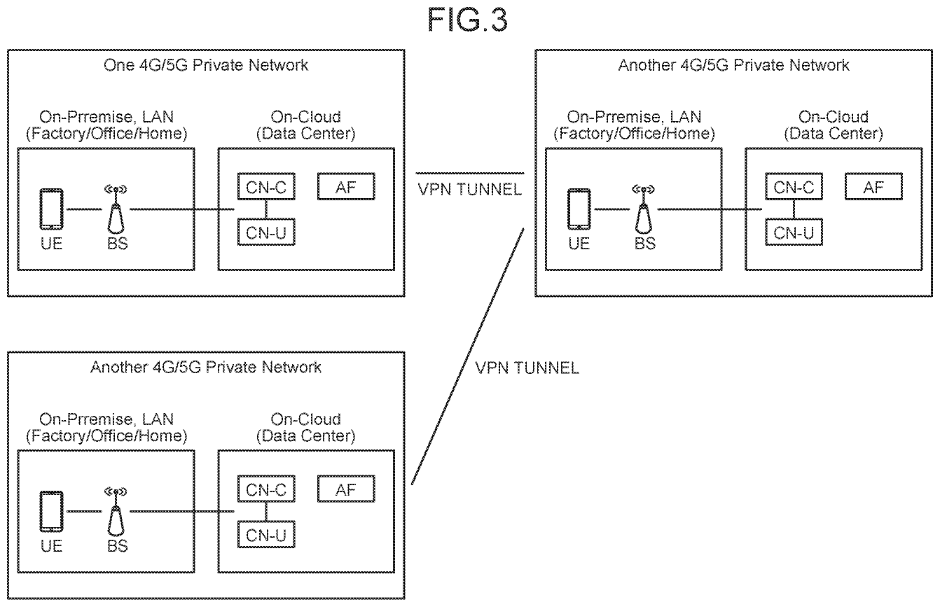

FIG. 3 is a diagram illustrating a communication system in a case where there is a plurality of 4G/5G private networks of a counterpart. In a case where the counterpart exists in plurality, as illustrated in FIG. 3, VPN tunnels are individually configured with the plurality of partners. Using a star connection is not desirable because of a large influence in a case of occurrence of a failure in a central switch. Also from the viewpoint of security, using a topology of 1:1 pairing is desirable because information is spread to the counterpart side alone.

Here is an assumable use case of a network in which a plurality of 4G/5G private networks are linked with each other. The following can be conceived as the use case.

### (1) Internet of Things (IoT)

There is a request to use an information processing device to control IoT devices disposed under the 4G/5G private network and extract information from the IoT devices. In this case, there is a problem that the scale of the IoT system is insufficient since the number of IoT sensors is limited only by controlling the IoT devices in one 4G/5G private network and acquiring information. This leads to a demand for collecting the information by linking a plurality of private networks. In this case, the location of the IoT device to communicate with is often known in advance. Since the TCP connection tends to impose a heavy power consumption load on the IoT device, the capability of communication using UDP is desired.

### (2) Game

There is a conceivable case, in playing a network game, where the counterpart belongs to a 4G/5G private network different from the player's. In this case, since the counterpart of communication is determined by the server of the game, who will be the communication counterpart is often not known until the last minute. In this case, it is considered that there are many cases where communication by UDP rather than TCP is desired in view of the constraint of latency.

### (3) Remote Monitoring

There may be a wish to monitor a video from a remote camera. Monitoring a video such as VR would require large capacity and low latency. When the monitoring video is highly critical information, it is desirable from the viewpoint of security to enable communication between 4G/5G private networks.

### (4) Others

The plurality of private networks are sometimes provided by different network service providers. It is desirable that one network service provider perform network management of a plurality of private networks. In this, however, the private networks are used by different customers. For example, it is assumed that there are customer A who measures wind power in Japan using an IoT sensor and customer B who measures wind power in Europe using an IoT sensor. It is further assumed that a terminal device of customer A is connected to private network A, and a terminal device of customer B is connected to private network B. At this time, it is assumed that network service provider C needs to collect information from the terminal devices of customers A and B using terminal devices connected to private network C. In this case, it is conceivable that business service provider C desires to link private networks A and B to each other.

### <1-4. RAMNF>

Connecting private networks with a VPN tunnel makes it possible to prevent information leakage during communication between the private networks. However, it is not desirable to randomly give information of the private network on the own side to the private network on the counterpart side. In particular, forwarding IP address information of the communication device to another private network outside one private network leads to leakage of personal information.

In view of these, in the present embodiment, a network function referred to as the Reachability Management Network Function (RAMNF) is disposed in each of two non-public cellular closed networks connected to each other by secure communication. Here, the “two non-public cellular closed networks connected to each other by secure communication” correspond to two 4G/5G private networks connected to each other by a VPN tunnel, for example.

The RAMNF acquires information related to a communication device connected to the non-public cellular closed network on the own side or the counterpart side, and performs, based on the acquired information, processing regarding packet arrival from the communication device connected to one of the two non-public cellular closed networks to the communication device connected to the other network. Here, the RAMNF may be one function of the core network or may be a function disposed outside the core network.

The RAMNF will be described below.

### <1-4-1. IP Address of Terminal Device and RAMNF>

In each 4G/5G private network, an IP address assigned to a terminal device by the core network can be held on the core network side. The IP address here may be either a local IP address or a global IP address. The RAMNF defined in the present embodiment obtains information regarding whether IP address has been assigned to the terminal device based on information from the core network. In a case where the IP address has been assigned, the RAMNF then holds the IP address of the terminal device in association with ID of the terminal device. With this configuration, the RAMNF that has received a request for message transmission from a client application installed in another terminal device or in another AF can transmit a UDP/TCP message from the network side. Since the UDP/TCP message can be directly transmitted from the network side, there is an advantage of low power consumption load on the terminal device as well as low latency. It is important to maintain this advantage even in a case where a plurality of 4G/5G private networks are linked with each other.

### <1-4-2. Other Roles of RAMNF>

The RAMNF plays an important role in delivering a packet to a sender side when connecting a plurality of 4G/5G private networks.

### (1) Name Resolution

Name resolution refers to acquisition of an IP address from an ID of a transmission destination or the like. The system such as a Domain Name System (DNS) usually performs name resolution. The RAMNF has a name resolution function. A difference from the normal DNS is that only two types of name resolution, that is, name resolution from the own side and name resolution from the paired counterpart side are performed. In normal name resolution, unknown names propagate to another DNS one after another. However, there is no such name propagation in the present embodiment that places importance on security.

### (2) Push Notification

Not only the DNS function of performing name resolution and returning an IP address, but there is provided also a push notification function of assigning an IP address of a terminal device to a message that has been sent based on an ID of the terminal device and sending the message with IP address. In normal push notification, a function existing outside the closed network is used, but in the present embodiment, the function is performed by the RAMNF disposed in the closed network. Furthermore, there is a large difference in that the RAMNF only functions for a request for message transmission from the two paired 4G/5G private networks.

### (3) Providing Information of State of Terminal Device

Using API named 5G Service Base Interface (SBI) (hereinafter referred to as 5G API), the RAMNF provides information such as a state of the terminal device, for example, whether the terminal device is in an Idle mode or a Connected mode, whether the IP address has been acquired or has not been acquired yet, to the sender side so as to enable the sender side to determine an appropriate time for message transmission. Exchanging the states of these terminal devices between RAMNF is one of the features of the present embodiment.

### <1-4-3. Number of RAMNF>

Regarding the question regarding the number of RAMNFs after the linkage of the plurality of 4G/5G private networks, it is desirable that one RAMNF be disposed in each of the 4G/5G private networks. A network topology of connecting a plurality of 4G/5G private networks in constant and permanent connection would require routing of packets across a plurality of networks, and this would increase a security threat. Therefore, it is desirable that the linkage of the 4G/5G private networks be made as a 1:1 pair connection, and the pair be cancelled when the paring becomes unnecessary. In consideration of this, it is desirable to dispose one RAMNF in one 4G/5G private network.

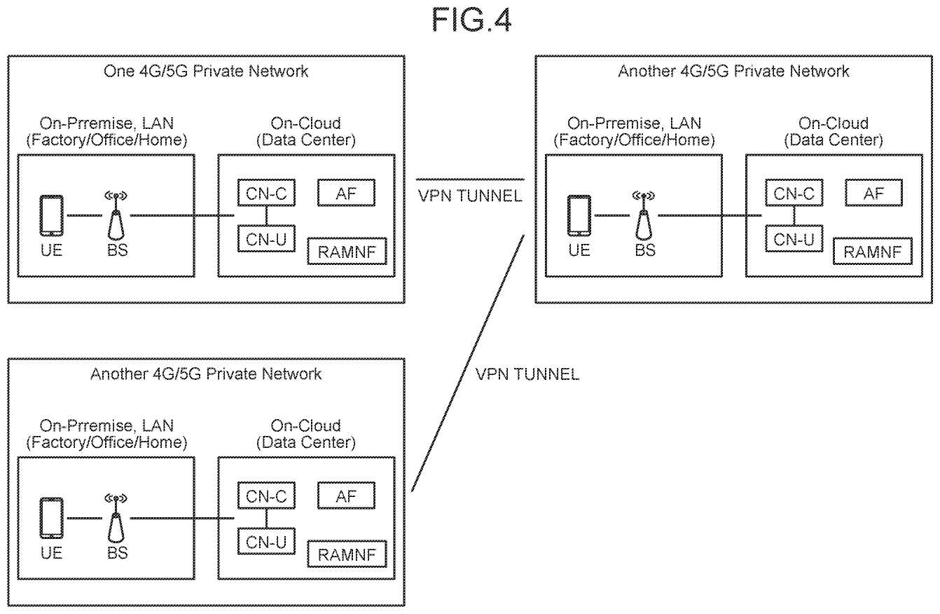

FIG. 4 is a diagram illustrating a state of disposing a RAMNF in each of a plurality of 4G/5G private networks. For example, in a case where 4G/5G private network A is linked with 4G/5G private network B and 4G/5G private network C, the information processing device that manages the private network needs to make a pair of A and B and a pair of A and C. In this case, B and C cannot communicate with each other. In consideration of this, it is desirable that one RAMNF be disposed in each of 4G/5G private networks A, B, and C.

### <1-4-4. Roles of Two Types of RAMNF and Packet Transmission Method>

As described above, since the 4G/5G private networks are connected in pairs, there are two RAMNFs in the pair of networks. The roles of the two RAMNFs will be described below.

Here is an assumable case where an application function (AF) transmits a message to a terminal device. Here, AF is a function of a communication device connected to one of two 4G/5G private networks. A terminal device is a communication device connected to the other of the 4G/5G private networks. AF may be referred to as a sender side communication device, and a terminal device may be referred to as a receiver side communication device.

In this case, the RAMNF on the terminal device side initially holds the IP address of the terminal device. Conceivable methods include Method 1 of holding the IP address only in the RAMNF on the terminal device side and Method 2 of holding the IP address also in the RAMNF on the AF side. Note that the RAMNF is an entity that has a function like a DNS as well as a function of managing reachability related to the state of the terminal device (such as a state of whether IP address is assigned, or a state of RRC IDLE/CONNECTED).

More specifically, the following Methods (1) to (5) are conceivable. Method 1 above corresponds to Methods in (1) to (3), and Method 2 above corresponds to Methods in (4) to (5).

### (1) Method 1-1

In Method 1-1, the AF transmits an IP packet storing a message together with ID specifying the terminal device to the RAMNF on the AF side. The RAMNF on the AF side specifies the RAMNF as a transmission destination among the 4G/5G private networks based on the ID specifying the terminal device. The RAMNF on the AF side assigns the IP address of the specified RAMNF to the IP packet, and forwards the packet to which the IP address has been assigned. The RAMNF on the terminal device side newly assigns the IP address of the terminal device to the packet and transmits the packet with the newly assigned IP address to the terminal device. In this method, because the IP address of the terminal device is held only in the RAMNF on the terminal device side, security threats are relatively low. In this method, the RAMNF on the AF side needs prior information from the ID of the terminal device in order to determine whether to transmit a packet to the RAMNF of the 4G/5G private network. However, since these processes are performed by the RAMNF, not by the AF, this method is considered to be better than the following Method 1-2 or Method 1-3.

### (2) Method 1-2

In Method 1-2, the AF acquires an IP address of the terminal device from the RAMNF on the terminal device side. The AF directly transmits the IP packet to the terminal device by using the IP address acquired.

### (3) Method 1-3

In Method 1-3, the AF transmits the IP packet storing ID specifying the terminal device and storing a message for the terminal device to the RAMNF on the terminal device side. Subsequently, the RAMNF on the terminal device side transmits the message to the terminal device. In this method, AF needs to hold information for determining to which RAMNF a message to be sent for each ID of the terminal device. In the case of this method, because the IP address of the terminal device is held only in the RAMNF on the terminal device side, security threats are relatively low. Note that sending a command for collecting information from a plurality of terminal devices as a message makes it necessary to manage IP addresses of a plurality of RAMNFs, leading to a disadvantage of a complicated configuration of the AF.

### (4) Method 2-1

In Method 2-1, the AF transmits an IP packet storing a message together with ID specifying the terminal device to the RAMNF on the AF side. The RAMNF on the AF side assigns the IP address of the terminal device to the IP packet and transmits the IP packet to which the IP address has been assigned, to the terminal device. In Method 1-1, the IP address of the terminal device needs to be forwarded from the RAMNF on the terminal device side to the RAMNF on the AF side. The number of locations for storing IP addresses increases from one to two, and together with this, security threats increase at the time of forwarding. In the case of Method 1-1, an AF operation may be a simple operation of sending a message to the RAMNF on the AF side. Note that the RAMNF on the AF side needs to take time for forwarding the reply from the terminal device to the AF.

### (5) Method 2-2

In Method 2-2, based on the ID of the terminal device, the AF sends an inquiry to the RAMNF on the AF side regarding the IP address of the terminal device. The AF directly transmits the IP packet to the terminal device by using the IP address acquired. Method 1-2 enables direct communication between the terminal device and the AF, leading to achievement of minimum latency.

In the above methods, one feature is the way in which the IP address of the terminal device is assigned to the packet. Passing the IP address of the terminal device from the RAMNF on the terminal device side directly to the AF on the counterpart side enables communication with lower latency. On the other hand, this method forwards the IP address to the most opposite side, causing an increased security threat. In contrast, not passing the IP address of the terminal device from the RAMNF on the terminal device side to the counterpart side would increase the communication latency.

Overall, the information processing device is considered to be important in selectively using the above-described Method 1-1, Method 2-1, and Method 2-2 according to the case. Therefore, in the present embodiment, Method 1-1, Method 2-1, and Method 2 2 will be mainly described.

### <<2. Configuration of Communication System>>

Before describing Method 1-1, Method 2-1, and Method 2-2, a configuration of communication system 1 will be described.

### <2-1. Overall Configuration of Communication System>

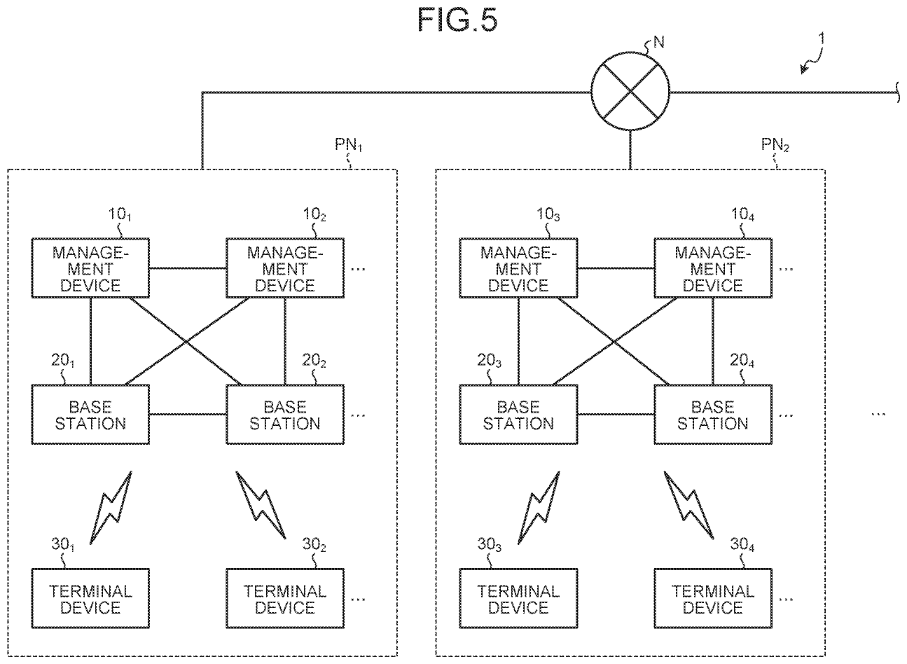

FIG. 5 is a diagram illustrating a configuration example of the communication system 1 according to the embodiment of the present disclosure. The communication system 1 includes a plurality of private networks PN. The private network PN is a private network using cellular wireless communication such as 4G or 5G, for example. The plurality of private networks PN are connected with each other via a network N. Although only one network N is illustrated in the example of FIG. 5, the network N may be provided in plurality.

Here, the network N is a public network such as the Internet, for example. The network N is not limited to the Internet, but may be other networks such as a local area network (LAN), a wide area network (WAN), a cellular network, a fixed-line telephone network, and a regional Internet protocol (IP) network, for example. The network N may include a wired network or a wireless network.

Each of the private networks PN includes a management device 10, a base station 20, and a terminal device 30. With individual wireless communication devices constituting the communication system 1 operating in cooperation with each other, the communication system 1 provides a user with a wireless network capable of mobile communication. The wireless network of the present embodiment includes a radio access network and a core network, for example. In the present embodiment, the wireless communication device is a device having a wireless communication function, and in the example of FIG. 5, the device corresponds to the base station 20 and the terminal device 30.

The communication system 1 may include a plurality of management devices 10, a plurality of base stations 20, and a plurality of terminal devices 30. In the example of FIG. 5, the communication system 1 includes management devices 101, 102, and so on as the management device 10, and includes base stations 201, 202 and so on as the base station 20. Furthermore, the communication system 1 includes terminal devices 301, 302, 303, and so on as the terminal device 30.

The device in the figure may be considered as a device in a logical sense. That is, parts of the device in the drawing may be partially actualized by a virtual machine (VM), a container, a docker, or the like, and they may be implemented on physically the same piece of hardware.

The communication system 1 may be compatible with a radio access technology (RAT) such as long term evolution (LTE) and new radio (NR). LTE and NR are a type of cellular communication technology, and enable mobile communication of terminal devices by using cellular arrangement of a plurality of areas covered by base stations.

The radio access method used by the communication system 1 is not limited to LTE and NR, and may be other radio access methods such as wideband code division multiple access (W-CDMA) and code division multiple access 2000 (cdma2000), for example.

Furthermore, the base station or the relay station constituting the communication system 1 may be a terrestrial station or a non-terrestrial station. The non-terrestrial station may be a satellite station or an aircraft station. If the non-terrestrial station is a satellite station, the communication system 1 may be a Bent-pipe (Transparent) mobile satellite communication system.

In the present embodiment, the terrestrial station (also referred to as a terrestrial base station) refers to a base station (a relay station) installed on the ground. The “ground” represents not only a land but also a terrestrial location in a broad sense including underground, above-water, and underwater. Note that, in the following description, the description of “terrestrial station” may be referred to as a “gateway”.

The base station in LTE may be referred to as Evolved Node B (eNodeB) or eNB. NR base stations may be referred to as gNodeB or gNB. In LTE and NR, a terminal device (also referred to as a mobile station, or terminal) may be referred to as user equipment (UE). The terminal device is a type of communication device, and is also referred to as a mobile station or a terminal.

In the present embodiment, the concept of the “communication device” includes not only a portable mobile device (terminal device) such as a mobile terminal but also a device installed in a structure or a mobile body. The structure or a mobile body itself may be regarded as a communication device. In addition, the concept of the communication device includes not only a terminal device but also a base station and a relay station. The communication device is a type of processing device and information processing device. The communication device can be paraphrased as a transmission device or a reception device.

Hereinafter, configurations of individual devices included in the communication system 1 will be specifically described. The configuration of each device illustrated below is just an example. The configuration of each device may differ from the configuration below.

### <2-2. Configuration of Management Device>

Next, a configuration of the management device 10 will be described.

The management device 10 is an information processing device (computer) that manages a wireless network. For example, the management device 10 is an information processing device that manages communication of the base station 20. The management device 10 may be a device having a function as a Mobility Management Entity (MME), for example. The management device 10 may be a device having a function as an Access and Mobility Management Function (AMF) and/or a Session Management Function (SMF). The functions of the management device 10 are not to be limited to the MME, the AMF, or the SMF. The management device 10 may be a device having a function as a Network Slice Selection Function (NSSF), an Authentication Server Function (AUSF), a Policy Control Function (PCF), or Unified Data Management (UDM). Furthermore, the management device 10 may be a device having a function as a Home Subscriber Server (HSS).

Note that the management device 10 may have a function of a gateway. For example, the management device 10 may have a function as a Serving Gateway (S-GW) or a Packet Data Network Gateway (P-GW). Furthermore, the management device 10 may have a function as a User Plane Function (UPF). In addition, the management device 10 may have a function as the Reachability

### Management Network Function (RAMNF).

The core network includes a plurality of network functions. Each network function may be integrated into one physical device or distributed to a plurality of physical devices. That is, the management device 10 can be disposed in a plurality of devices as distributed arrangement. Further, this distributed arrangement may be controlled to be performed dynamically. The base station 20 and the management device 10 constitute one network, and provide a wireless communication service to the terminal device 30. The management device 10 is connected to the Internet, and the terminal device 30 can use various services provided over the Internet via the base station 20.

Note that the management device 10 does not necessarily have to be a device constituting a core network. For example, it is assumed that the core network is a core network of Wideband Code Division Multiple Access (W-CDMA) or Code Division Multiple Access 2000 (cdma2000). At this time, the management device 10 may be a device that functions as a Radio Network Controller (RNC).

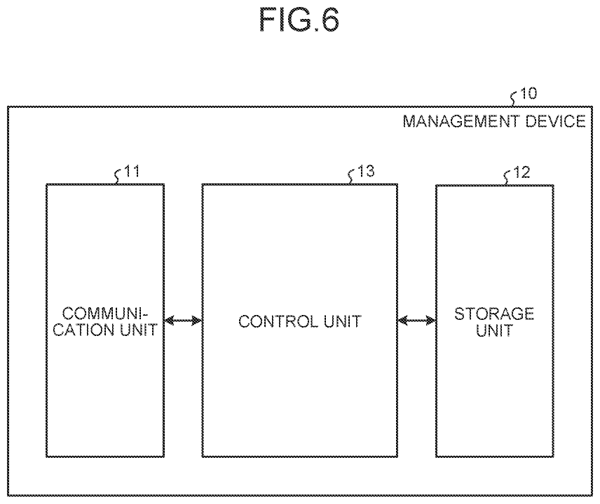

FIG. 6 is a diagram illustrating a configuration example of the management device 10 according to an embodiment of the present disclosure. The management device 10 includes a communication unit 11, a storage unit 12, and a control unit 13. Note that the configuration illustrated in FIG. 6 is a functional configuration, and the hardware configuration may be different from this. Furthermore, the functions of the management device 10 may be implemented in a statically or dynamically distributed form in a plurality of physically separated configurations. For example, the management device 10 may be constituted with a plurality of server devices.

The communication unit 11 is a communication interface for communicating with other devices. The communication unit 11 may be a network interface, or may be a device connection interface. For example, the communication unit 11 may be a local area network (LAN) interface such as a network interface card (NIC), or may be a universal serial bus (USB) interface including a USB host controller, a USB port, and the like. Furthermore, the communication unit 11 may be a wired interface, or may be a wireless interface. The communication unit 11 functions as a communication means of the management device 10. The communication unit 11 communicates with the base station 20 and the like under the control of the control unit 13.

The storage unit 12 is a data readable/writable storage device such as dynamic random access memory (DRAM), static random access memory (SRAM), a flash drive, or a hard disk. The storage unit 12 functions as a storage means in the management device 10. The storage unit 12 stores, for example, a connection state of the terminal device 30. For example, the storage unit 12 stores a Radio Resource Control (RRC) state or an EPS connection management (ECM) state or a 5G system connection management (CM) state of the terminal device 30. The storage unit 12 may function as a unit referred to as “home memory” that stores positional information of the terminal device 30.

The control unit 13 is a controller that controls individual components of the management device 10. The control unit 13 is implemented by a processor such as a central processing unit (CPU), a micro processing unit (MPU), or a graphics processing unit (GPU), for example. For example, the control unit 13 is actualized by execution of various programs stored in the storage device inside the management device 10 by the processor using random access memory (RAM) or the like as a work area. Note that the control unit 13 may be implemented by an integrated circuit such as an application specific integrated circuit (ASIC) or a field programmable gate array (FPGA). The CPU, MPU, GPU, ASIC, and FPGA can all be regarded as controllers.

### <2-3. Configuration of Base Station>

Next, a configuration of the base station 20 will be described.

The base station 20 is a wireless communication device that performs wireless communication with the terminal device 30. The base station 20 may be configured to perform wireless communication with the terminal device 30 via a relay station, or may be configured to directly perform wireless communication with the terminal device 30.

The base station 20 is a type of communication device. The base station 20 is, for example, a device corresponding to a radio base station (Base Station, Node B, eNB, gNB, etc.) or a radio access point. The base station 20 may be a radio relay station. Furthermore, the base station 20 may be an optical link device referred to as a Remote Radio Head (RRH) or a Radio Unit (RU). Furthermore, the base station 20 may be a receiving station such as a Field Pickup Unit (FPU). In addition, the base station 20 may be an Integrated Access and Backhaul (IAB) donor node or an IAB relay node that provides a radio access channel and a radio backhaul channel by using time division multiplexing, frequency division multiplexing, or space division multiplexing.

Note that the radio access technology used by the base station 20 may be a cellular communication technology or a wireless LAN technology. Needless to say, the radio access technology used by the base station 20 is not limited thereto, and may be other radio access technologies. For example, the radio access technology used by the base station 20 may be a low power wide area (LPWA) communication technology. Needless to say, the wireless communication used by the base station 20 may be wireless communication using millimeter waves. Furthermore, the wireless communication used by the base station 20 may be wireless communication using radio waves or wireless communication (optical wireless communication) using infrared rays or visible light.

The base station 20 may be capable of Non-Orthogonal Multiple Access (NOMA) communication with the terminal device 30. Here, NOMA communication refers to communication (transmission, reception, or both) using non-orthogonal resources. Note that the base station 20 may be capable of performing NOMA communication with another base station 20.

The base station 20 may be capable of communicating with each other via a base station-core network interface (for example, NG Interface, S1 Interface, or the like). This interface may be implemented as wired or wireless interface. Furthermore, the base stations may be capable of communicating with each other via an inter-base station interface (for example, Xn Interface, X2 Interface, S1 Interface, F1 Interface, or the like). This interface may be implemented as wired or wireless interface.

Note that the concept of the base station includes not only a donor base station but also a relay base station (also referred to as a relay station). For example, the relay base station may be any one of RF Repeater, Smart Repeater, and Intelligent Surface. Furthermore, a base station conceptually includes not only a structure having a function of a base station but also a device installed in the structure.

Examples of the structure include a building such as a high-rise building, a house, a steel tower, a station facility, an airport facility, a harbor facility, an office building, a school building, a hospital, a factory, a commercial facility, or a stadium. The concept of the structure includes not only buildings but also non-building structures such as tunnels, bridges, dams, fences, and steel columns, as well as facilities such as cranes, gates, and windmills. In addition, a structure conceptually includes not only land-based (ground-based, in a narrow sense) structures or underground structures but also structures on the water, such as a jetty and a mega-float, and underwater structures such as an ocean observation facility. The base station may be referred to as an information processing device.

The base station 20 may be a donor station or a relay station. The base station 20 may be a fixed station or a mobile station. The mobile station is a wireless communication device (for example, a base station) configured to be movable. At this time, the base station 20 may be a device installed on a mobile body, or may be a mobile body itself. For example, a relay station having mobility can be regarded as the base station 20 as a mobile station. In addition, a device designed to have mobility, such as an Unmanned Aerial Vehicle (UAV) represented by a drone, or a smartphone, and having a function of a base station (at least a part of the function of a base station) also corresponds to the base station 20 as a mobile station.

Here, the mobile body may be a mobile terminal such as a smartphone or a mobile phone. The mobile body may be a mobile body that moves on the land (ground in a narrow sense) (for example, a vehicle such as an automobile, a motorcycle, a bus, a truck, a motorbike, a train, or a linear motor car), or a mobile body (for example, subway) that moves under the ground (for example, through a tunnel).

The mobile body may be a mobile body that moves on the water (for example, a ship such as a passenger ship, a cargo ship, and a hovercraft), or a mobile body that moves underwater (for example, a submersible ship such as a submersible boat, a submarine, or an unmanned submarine).

The mobile body may be a mobile body that moves in the atmosphere (for example, an aircraft such as an airplane, an airship, or a drone).

Furthermore, the base station 20 may be a terrestrial base station (terrestrial station) installed on the ground. For example, the base station 20 may be a base station disposed on a structure on the ground, or may be a base station installed in a mobile body moving on the ground. More specifically, the base station 20 may be an antenna installed in a structure such as a building and a signal processing device connected to the antenna. Note that the base station 20 may be a structure or a mobile body itself. The “ground” represents not only a land (ground in a narrow sense) but also a terrestrial location in a broad sense including underground, above-water, and underwater. Note that the base station 20 is not limited to a terrestrial base station. For example, in a case where the communication system 1 is a satellite communication system, the base station 20 may be an aircraft station. From the perspective of a satellite station, an aircraft station located on the earth is a terrestrial station.

Note that the base station 20 is not limited to a terrestrial station. The base station 20 may be a non-terrestrial base station (non-terrestrial station) capable of floating in the air or space. For example, the base station 20 may be an aircraft station or a satellite station.

The satellite station is a satellite station capable of floating outside the atmosphere. The satellite station may be a device mounted on a space mobile body such as an artificial satellite, or may be a space mobile body itself. A space mobile body is a mobile body that moves outside the atmosphere. Examples of the space mobile body include artificial bodies such as artificial satellites, spacecraft, space stations, and probes.

The satellite serving as the satellite station may be any of a low earth orbiting (LEO) satellite, a medium earth orbiting (MEO) satellite, a geostationary earth orbiting (GEO) satellite, or a highly elliptical orbiting (HEO) satellite. Accordingly, the satellite station may be a device mounted on a low earth orbiting satellite, a medium earth orbiting satellite, a geostationary earth orbiting satellite, or a highly elliptical orbiting satellite.

The aircraft station is a wireless communication device capable of floating in the atmosphere, such as an aircraft. The aircraft station may be a device mounted on an aircraft or the like, or may be an aircraft itself. The concept of the aircraft includes not only heavy aircraft such as an airplane and a glider but also light aircraft such as a balloon and an airship. In addition, the concept of the aircraft includes not only a heavy aircraft and a light aircraft but also a rotorcraft such as a helicopter and an auto-gyro. Note that the aircraft station (or an aircraft on which an aircraft station is mounted) may be an unmanned aerial vehicle such as a drone.

Note that the concept of the unmanned aerial vehicle also includes an unmanned aircraft system (UAS) and a tethered UAS. The concept of unmanned aerial vehicles also includes a Lighter-than-Air (LTA) unmanned aircraft system (UAS) and a Heavier-than-Air (HTA) unmanned aircraft system (UAS). Other concepts of unmanned aerial vehicles also include High Altitude Platforms (HAPs) unmanned aircraft system (UAS).

The coverage of the base station 20 may be large such as a macro cell or small such as a pico cell. Needless to say, the coverage of the base station 20 may be extremely small such as a femto cell. Furthermore, the base station 20 may have a beamforming capability. In this case, the base station 20 may form a cell or a service area for each beam.

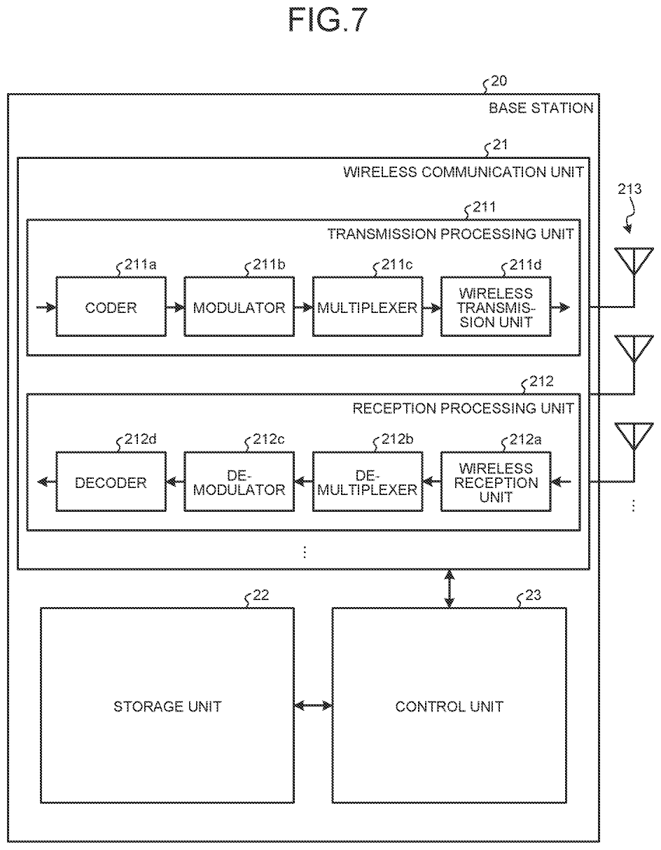

FIG. 7 is a diagram illustrating a configuration example of the base station 20 according to the embodiment of the present disclosure. The base station 20 includes a wireless communication unit 21, a storage unit 22, and a control unit 23. Note that the configuration illustrated in FIG. 7 is a functional configuration, and the hardware configuration may be different from this. Furthermore, the functions of the base station 20 may be implemented in a distributed form in a plurality of physically separated configurations.

The wireless communication unit 21 is a signal processing unit for performing wireless communication with other wireless communication devices (for example, the terminal device 30). The wireless communication unit 21 operates under the control of the control unit 23. The wireless communication unit 21 may support one or a plurality of radio access methods. For example, the wireless communication unit 21 supports both NR and LTE. The wireless communication unit 21 may support W-CDMA or cdma2000 in addition to NR and LTE. Furthermore, the wireless communication unit 21 may support an automatic retransmission technology such as Hybrid Automatic Repeat reQuest (HARQ).

The wireless communication unit 21 includes a transmission processing unit 211, a reception processing unit 212, and an antenna 213. The wireless communication unit 21 may include a plurality of the transmission processing units 211, a plurality of the reception processing units 212, and a plurality of the antennas 213. In a case where the wireless communication unit 21 supports a plurality of radio access methods, individual portions of the wireless communication unit 21 can be configured separately for each of the radio access methods. For example, the transmission processing unit 211 and the reception processing unit 212 may be individually configured for LTE and NR. Furthermore, the antenna 213 may include a plurality of antenna elements (for example, a plurality of patch antennas). In this case, the wireless communication unit 21 may be configured to be capable of beamforming. The wireless communication unit 21 may be configured to be able to perform polarization beamforming using vertically polarized waves (V-polarized waves) and horizontally polarized waves (H-polarized waves).

The transmission processing unit 211 performs transmission processing of downlink control information and downlink data. The transmission processing unit 211 codes the downlink control information and the downlink data input from the control unit 23 by using a coding method such as block coding, convolutional coding, or turbo coding. The coder may perform coding using a polar code or a Low Density Parity Check (LDPC) code. The transmission processing unit 211 modulates the coded bits by a predetermined modulation scheme such as BPSK, QPSK, 16 QAM, 64 QAM, or 256 QAM. In this case, the signal points on the constellation do not necessarily have to be equidistant. The constellation may be a non-uniform constellation (NUC). The transmission processing unit 211 multiplexes the modulation symbol of each of channels and the downlink reference signal and allocates the multiplexed signals on a predetermined resource element. Subsequently, the transmission processing unit 211 performs various types of signal processing on the multiplexed signal. For example, the transmission processing unit 211 performs processing such as conversion to the frequency domain using fast Fourier transform, addition of a guard interval (cyclic prefix), generation of a baseband digital signal, conversion to an analog signal, quadrature modulation, upconvert, removal of extra frequency components, and power amplification. The signal generated by the transmission processing unit 211 is transmitted from the antenna 213.

The reception processing unit 212 processes an uplink signal received via the antenna 213. For example, the reception processing unit 212 performs processing on the uplink signal, such as down-conversion, removal of unnecessary frequency components, amplification level control, orthogonal demodulation, conversion to digital signal, removal of guard interval (cyclic prefix), and frequency domain signal extraction using fast Fourier transform. The reception processing unit 212 then demultiplexes an uplink channel such as a physical uplink shared channel (PUSCH) or a physical uplink control channel (PUCCH) and an uplink reference signal from the signal that has undergone these processing procedures. Subsequently, the reception processing unit 212 demodulates a received signal using a modulation scheme such as binary phase shift keying (BPSK) or quadrature phase shift keying (QPSK) for the modulation symbol of the uplink channel. The modulation scheme used in the demodulation may be 16 quadrature amplitude modulation (QAM), 64 QAM, or 256 QAM. In this case, the signal points on the constellation do not necessarily have to be equidistant. The constellation may be a non-uniform constellation (NUC). Subsequently, the reception processing unit 212 performs decoding processing on the coded bits of the demodulated uplink channel. The decoded uplink data and uplink control information are output to the control unit 23.

The antenna 213 is an antenna device (antenna unit) that performs mutual conversion of a current and a radio wave. The antenna 213 may include one antenna element (for example, one patch antenna) or may include a plurality of antenna elements (for example, a plurality of patch antennas). In a case where the antenna 213 includes a plurality of antenna elements, the wireless communication unit 21 may be configured to be capable of beamforming. For example, the wireless communication unit 21 may control the directivity of a wireless signal using a plurality of antenna elements to generate a directional beam. The antenna 213 may be a dual polarized antenna. When the antenna 213 is a dual polarized antenna, the wireless communication unit 21 may use a vertically polarized wave (V polarized wave) and a horizontally polarized wave (H polarized wave) when sending radio signals. Then, the wireless communication unit 21 may control the directivity of the wireless signal transmitted using the vertically polarized wave and the horizontally polarized wave. Furthermore, the wireless communication unit 21 may transmit and receive spatially multiplexed signals via a plurality of layers including a plurality of antenna elements.

The storage unit 22 is a data readable/writable storage device such as DRAM, SRAM, a flash drive, and a hard disk. The storage unit 22 functions as a storage means in the base station 20.

The control unit 23 is a controller that controls individual components of the base station 20. The control unit 23 is implemented by a processor such as a central processing unit (CPU) or a micro processing unit (MPU), for example. For example, the control unit 23 is implemented by execution of various programs stored in the storage device inside the base station 20 by the processor using random access memory (RAM) or the like as a work area. Note that the control unit 23 may be implemented by an integrated circuit such as an application specific integrated circuit (ASIC) or a field programmable gate array (FPGA). The CPU, MPU, ASIC, and FPGA can all be regarded as controllers. Furthermore, the control unit 23 may be implemented by a graphics processing unit (GPU) in addition to or instead of the CPU.

In some embodiments, the concept of a base station may be constituted with a collection of a plurality of physical or logical devices. For example, in the present embodiment, the base station may be classified into a plurality of devices such as a Baseband Unit (BBU) and a Radio Unit (RU). The base station may be interpreted as an assembly of the plurality of devices. In addition, the base station may be either or both of a BBU and an RU. The BBU and the RU may be connected by a predetermined interface (for example, an enhanced Common Public Radio Interface (eCPRI)). The RU may be referred to as a Remote Radio Unit (RRU) or a Radio DoT (RD). The RU may correspond to a gNB Distributed Unit (gNB-DU) described below. The BBU may correspond to a gNB Central Unit) (gNB-CU) described below. Alternatively, the RU may be a wireless device connected to a qNB-DU described below. The gNB-CU, the gNB-DU, and the RU connected to the gNB-DU may be configured to conform to an Open Radio Access Network (O-RAN). The RU may be a device integrally formed with an antenna. An antenna (for example, an antenna integrally formed with an RU) included in the base station may adopt an Advanced Antenna System and support MIMO (for example, FD-MIMO) or beamforming. For example, the antenna included in the base station may include 64 sending antenna ports and 64 receiving antenna ports.

In addition, the antenna mounted on the RU may be an antenna panel including one or more antenna elements, and the RU may include one or more antenna panels. For example, the RU may include two types of antenna panels of a horizontally polarized antenna panel and a vertically polarized antenna panel, or two types of antenna panels of a clockwise (right-hand) circularly polarized antenna panel and a counterclockwise (left-hand) circularly polarized antenna panel. In addition, the RU may form and control an independent beam for each antenna panel.

The plurality of base stations may be connected to each other. One or the plurality of base stations may be included in a Radio Access Network (RAN). That is, the base station may be simply referred to as a RAN, a RAN node, an Access Network (AN), or an AN node. RAN in LTE may be referred to as Enhanced Universal Terrestrial RAN (EUTRAN). In addition, RAN in NR may be referred to as NGRAN. RAN in W-CDMA (UMTS) may be referred to as UTRAN.

The base station in LTE may be referred to as Evolved Node B (eNodeB) or eNB. That is, EUTRAN includes one or a plurality of eNodeB (eNB). NR base stations may be referred to as gNodeB or gNB. At this time, NGRAN contains one or a plurality of gNBs. EUTRAN may include gNB (en-gNB) connected to the core network (EPC) in LTE communication systems (EPS). Similarly, NGRAN may include an ng-eNB connected to the core network 5GC in a 5G communication system (5GS).

When the base station is eNB, qNB, or the like, the base station may be referred to as 3GPP access. Furthermore, when the base station is a radio access point, the base station may be referred to as non-3GPP access. The base station may be an optical link device referred to as a Remote Radio Head (RRH) or a Radio Unit (RU). Furthermore, in a case where the base station is a gNB, the base station may be a combination of the qNB-CU and the gNB-DU described above, or may be any one of the gNB-CU and the gNB-DU.

Here, in order to have a communication with the UE, the gNB-CU hosts a plurality of upper layers (for example, Radio Resource Control (RRC), Service Data Adaptation Protocol (SDAP), and Packet Data Convergence Protocol (PDCP)) in an access stratum. On the other hand, the gNB-DU hosts a plurality of lower layers (for example, radio link control (RLC), Medium Access Control (MAC), and Physical Layer (PHY)) in an access stratum. That is, among messages/information to be described below, RRC signaling (semi-static notification) may be generated by the gNB-CU, while MAC CE and DCI (dynamic notification) may be generated by the gNB-DU. Alternatively, among the RRC configurations (semi-static notifications), some configurations such as IE: cellGroupConfig may be generated by the gNB-DU, while the remaining configurations may be generated by the gNB-CU, for example. These configurations may be transmitted and received through an F1 interface described below.

The base station may be configured to be able to communicate with another base station. For example, when a plurality of base stations is eNB each or a combination of eNBs and en-gNBs, the base stations may be connected to each other by an X2 interface. Furthermore, when a plurality of base stations is gNB each or a combination of gn-eNB and gNB, the devices may be connected to each other by an Xn interface. Furthermore, when a plurality of base stations is a combination of gNB CU and gNB DU, the devices may be connected to each other by the F1 interface described above. The message/information (for example, RRC signaling, MAC control element (MAC CE), or DCI) described below may be transmitted between a plurality of base stations via the X2 interface, the Xn interface, or the F1 interface, for example.

The cell provided by the base station may be referred to as a serving cell. The serving cell conceptually includes a primary cell (PCell) and a secondary cell (SCell). When dual connectivity is configured for the UE (for example, the terminal device 30), the PCell provided by a Master Node (MN) and zero or one or more SCells may be referred to as a Master Cell Group. Examples of dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity.

The serving cell may include a Primary Secondary Cell or Primary SCG Cell (PSCell). In a case where dual connectivity is configured in the UE, the PSCell and the zero or one or more SCells provided by a secondary node (SN) may be referred to as Secondary Cell Group (SCG). Unless specially configured (for example, PUCCH on SCell), a physical uplink control channel (PUCCH) is transmitted in the PCell and the PSCell, but is not transmitted in the SCell. In addition, a radio link failure is also detected in the PCell and the PSCell, but is not detected in the SCell (need not be detected). In this manner, since the PCell and the PSCell have a special role in the serving cell, these cells are also referred to as Special Cells (SpCells).

One cell may be associated with one downlink component carrier and one uplink component carrier. In addition, the system bandwidth corresponding to one cell may be divided into a plurality of bandwidth parts (BWPs). In this case, one or a plurality of BWPs may be configured for the UE, and one BWP may be used for the UE as an active BWP. In addition, radio resources (for example, a frequency band, a numerology (subcarrier spacing), and a slot format (slot configuration)) usable by the terminal device 30 may be different for each cell, each component carrier, or each BWP.

### <2-4. Configuration of Terminal Device>

Next, a configuration of the terminal device 30 will be described.

The terminal device 30 is a wireless communication device that performs wireless communication with other communication devices such as the base station 20. Examples of the terminal device 30 include a mobile phone, a smart device (smartphone or tablet), a personal digital assistant (PDA), or a personal computer. Furthermore, the terminal device 30 may be a device such as a business camera equipped with a communication function, or may be a motorcycle, a moving relay vehicle, or the like on which communication equipment such as a field pickup unit (FPU) is mounted. The terminal device 30 may be a machine to machine (M2M) device or an Internet of Things (IoT) device.

The terminal device 30 may be capable of performing NOMA communication with the base station 20. Furthermore, the terminal device 30 may be able to use an automatic retransmission technology such as HARQ when communicating with the base station 20. Furthermore, the terminal device 30 may be capable of sidelink communication with another terminal device 30. The terminal device 30 may be capable of using an automatic retransmission technology such as HARQ also at the time of performing sidelink communication. The terminal device 30 may also be capable of NOMA communication in the communication (sidelink) with another terminal device 30. Furthermore, the terminal device 30 may be capable of LPWA communication with other communication devices (for example, the base station 20 or another terminal device 30). In addition, the wireless communication used by the terminal device 30 may be wireless communication using millimeter waves. The wireless communication (including sidelink communication) used by the terminal device 30 may be wireless communication using radio waves or wireless communication using infrared rays or visible light (optical wireless communication).

Furthermore, the terminal device 30 may be a mobile device. The mobile device is a movable wireless communication device. At this time, the terminal device 30 may be a wireless communication device installed on a mobile body, or may be the mobile body itself. For example, the terminal device 30 may be a vehicle that moves on a road, such as an automobile, a bus, a truck, or a motorbike, may be a vehicle traveling on a rail installed in the track of a train or the like, or may be a wireless communication device mounted on the vehicle. The mobile body may be a mobile terminal, or may be a mobile body that moves on land (on the ground in a narrow sense), in the ground, on water, or under water. Furthermore, the mobile body may be a mobile body that moves inside the atmosphere, such as a drone or a helicopter, or may be a mobile body that moves outside the atmosphere, such as an artificial satellite.

The terminal device 30 may perform communication while being simultaneously connected to a plurality of base stations or a plurality of cells. For example, when one base station supports a communication area via a plurality of cells (for example, pCell and sCell), it is possible to bundle the plurality of cells and communicate between the base station 20 and the terminal device 30 by using a carrier aggregation (CA) technology, a dual connectivity (DC) technology, or a multi-connectivity (MC) technology. Alternatively, the terminal device 30 and the plurality of base stations 20 can communicate with each other by a Coordinated Multi-Point Transmission and Reception (COMP) technology via cells of different base stations 20.

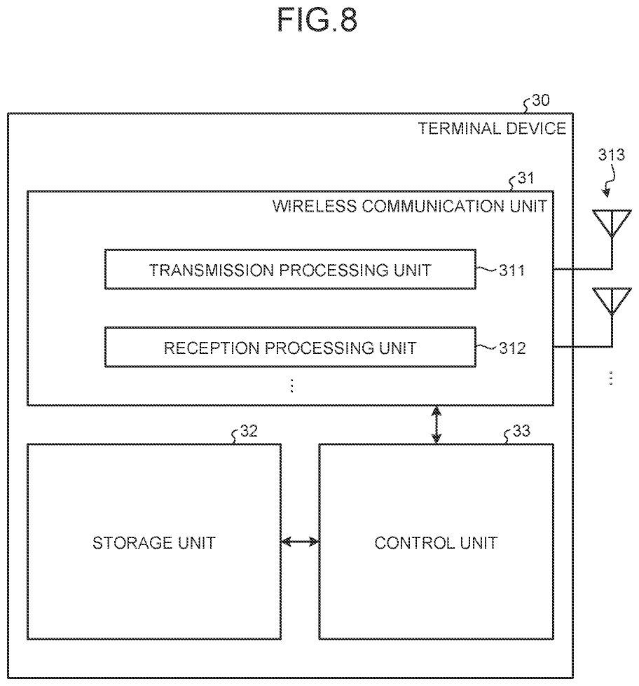

FIG. 8 is a diagram illustrating a configuration example of the terminal device 30 according to the embodiment of the present disclosure. The terminal device 30 includes a wireless communication unit 31, a storage unit 32, and a control unit 33. Note that the configuration illustrated in FIG. 8 is a functional configuration, and the hardware configuration may be different from this. Furthermore, the functions of the terminal device 30 may be implemented in a distributed form in a plurality of physically separated configurations.

The wireless communication unit 31 is a signal processing unit for performing wireless communication with other wireless communication devices (for example, the base station 20 and another terminal device 30). The wireless communication unit 31 operates under the control of the control unit 33. The wireless communication unit 31 includes a transmission processing unit 311, a reception processing unit 312, and an antenna 313. The configurations of the wireless communication unit 31, the transmission processing unit 311, the reception processing unit 312, and the antenna 313 may be similar to the configurations of the wireless communication unit 21, the transmission processing unit 211, the reception processing unit 212, and the antenna 213 of the base station 20. Furthermore, the wireless communication unit 31 may be configured to be capable of beamforming similarly to the wireless communication unit 21. Further, similarly to the wireless communication unit 21, the wireless communication unit 31 may be capable of sending and receiving spatially multiplexed signals.

The storage unit 32 is a data readable/writable storage device such as DRAM, SRAM, a flash drive, and a hard disk. The storage unit 32 functions as a storage means in the terminal device 30.

The control unit 33 is a controller that controls individual parts of the terminal device 30. The control unit 33 is actualized by a processor such as a CPU or an MPU, for example. For example, the control unit 33 is implemented by a processor executing various programs stored in a storage device inside the terminal device 30 using RAM or the like as a work area. Note that the control unit 33 may be implemented by an integrated circuit such as an ASIC or an FPGA. The CPU, MPU, ASIC, and FPGA can all be regarded as controllers. The control unit 33 may be implemented by a GPU in addition to or instead of the CPU.

### <<3. Network Architecture>>

The configuration of the communication system 1 has been described above. Next, a network architecture applicable to the communication system 1 of the present embodiment will be described.

### <3-1. Configuration Example of 5G Network Architecture>

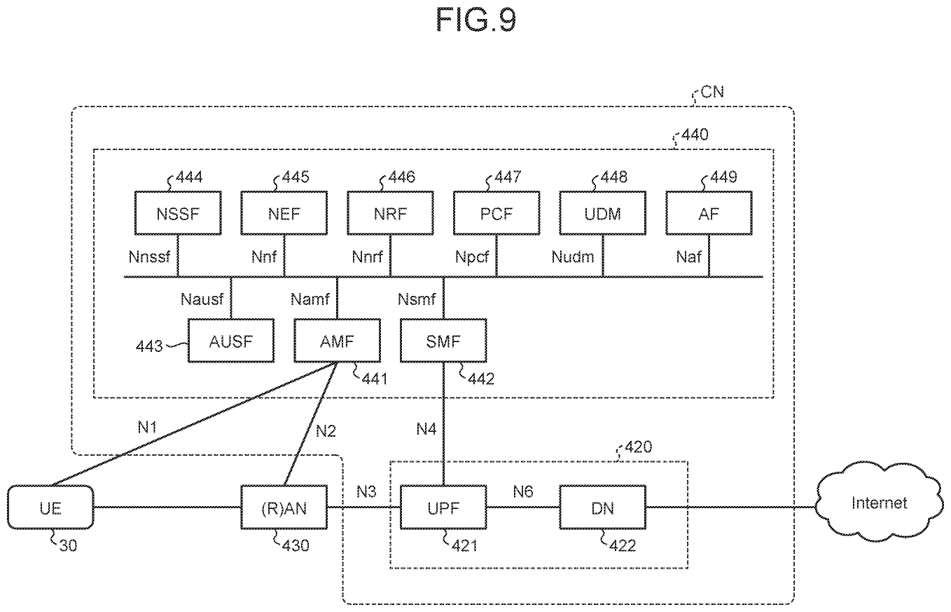

First, an architecture of a fifth generation mobile communication system (5G) will be described as an example of a core network CN of the communication system 1. FIG. 9 is a diagram illustrating an example of a 5G architecture. The core network CN of 5G is also referred to as 5G Core (5GC)/Next Generation Core (NGC). Hereinafter, the core network CN of 5G is also referred to as a 5GC/NGC. The core network CN is connected to User Equipment (UE) 30 via a (R) AN 430. An example of the UE 30 is the terminal device 30. Although the core network CN illustrated in FIG. 9 does not include the RAMNF, the core network CN may include the RAMNF as one of the network functions. Needless to say, the network function may be a network function disposed outside the RAMNF core network CN.

The (R) AN 430 has a function of enabling the connection to a radio access network (RAN) and the connection to an Access Network (AN) other than RAN. The (R) AN 430 includes a base station referred to as a gNB or an ng-eNB.

The core network CN mainly performs connection permission and session management when the UE 30 is connected to the network. The core network CN may include a user plane function group 420 and a control plane function group 440.

The user plane function group 420 includes a user plane function (UPF) 421 and a data network (DN) 422. The UPF 421 has a function of user plane processing. The UPF 421 includes a routing/forwarding function of data handled in the user plane. The DN 422 has a function of providing an entity, such as a Mobile Network Operator (MNO), which provides a connection to an operator's own service, providing an Internet connection, or providing a connection to a third party service. In this manner, the user plane function group 420 plays a role of a gateway as a boundary between the core network CN and the Internet.

The control plane function group 440 includes an access management function (AMF) 441, a session management function (SMF) 442, an authentication server function (AUSF) 443, a network slice selection function (NSSF) 444, a network exposure function (NEF) 445, a network repository function (NRF) 446, a policy control function (PCF) 447, a unified data management (UDM) 448, and an application function (AF) 449.

The AMF 441 has functions such as registration processing, connection management, and mobility management regarding the UE 30. The SMF 442 has functions such as session management and IP allocation and management of the UE 30. The AUSF 443 has an authentication function. The NSSF 444 has a function related to selection of a network slice. The NEF 445 has a function of providing a capability and an event of a network function to a third party, the AF 449, or an edge computing function.

The NRF 446 has a function of discovering network functions and holding network function profiles. The PCF 447 has a function of policy control. The UDM 448 has functions of generating 3GPP AKA authentication information and user ID processing. The AF 449 has a function of providing a service in interaction with the core network.

For example, the control plane function group 440 acquires information from the UDM 448 storing subscriber information of the UE 30, and determines whether the UE 30 is permitted to connect to the network. In this determination, the control plane function group 440 uses the contract information of the UE 30 and an encryption key included in the information acquired from the UDM 448. In addition, the control plane function group 440 performs operations such as generation of the encryption key.

That is, the control plane function group 440 determines whether to permit network connection according to whether the UDM 448 stores information of the UE 30 associated with a subscriber number referred to as International Mobile Subscriber Identity (IMSI), for example. Note that the IMSI is stored in a Subscriber Identity Module (SIM) card in the UE 30, for example.

Here, Namf is a service-based interface provided by the AMF 441, and Nsmf is a service-based interface provided by the SMF 442. In addition, Nnef is a service-based interface provided by the NEF 445, and Npcf is a service-based interface provided by the PCF 447. Nudm is a service-based interface provided by the UDM 448, and Naf is a service-based interface provided by the AF 449. Nnrf is a service-based interface provided by the NRF 446, and Nnssf is a service-based interface provided by the NSSF 444. Nausf is a service-based interface provided by the AUSF 443. Each of these network functions (NFs) exchanges information with another NF via each service-based interface.

In FIG. 9, N1 illustrated is a reference point between the UE 30 and the AMF 441, while N2 is a reference point between the RAN/AN 430 and the AMF 441. N4 is a reference point between the SMF 442 and the UPF 421, and information is exchanged between these network functions (NFs).

As described above, the core network CN is provided with an interface used in sending information and controlling functions via an Application Programming Interface (API).

The API enables designation of a resource, and operations on the resource, such as GET (resource acquisition), POST (creation of resource and addition of data), PUT (create resource, update resource), and DELETE (resource deletion). Such a function is typically used in the technical field related to the Web, for example.

For example, the AMF 441, the SMF 442, and the UDM 448 illustrated in FIG. 9 exchange information with each other using the API when establishing a communication session. Conventionally, such an API is not assumed to be used by an application (for example, AF 449). However, using such an API by the AF 449 makes it possible for the AF 449 to use 5G cellular network information, leading to further evolution of functions of the application.

Note that it is difficult for the AF 289 to use the API used by the AMF 441, the SMF 442, and the UDM 448 in a public network. However, in the case of a non-public private 5G network, it is considered to be able to achieve a system configuration including a change in the API of the core network CN so that the AF 289 can use such an API.

Here, an example of the API will be described. API (1) to API (4) described here are described in 3GPP TS 23.502.

### API (1)

API (1) is an API used by SMF 442 for notification of the fact that the pre-registered UE 30 has transitioned from the power off state to the power on state and attached to the network and notification of the IP address acquired at that time.

The SMF 442 uses the API (1) to notify the NF about acquisition of the IP address by the UE 30 of the registered IMSI.

### API (2)

The UE 30 enters the Idle mode while not in communication, and transitions to the Connected mode when starting communication. The API (2) is an API by which the AMF 441 notifies whether the UE 30 is in the Idle mode or the Connected mode.

### API (3)

The API (3) is an API used for broadcasting, from the base station, a message (Paging message) for instructing the UE 30 to transition from the Idle mode to the Connected mode.

### API (4)

The API (4) is an API by which the AMF 441 provides the location information of the UE 30. The AMF 441 may use the API (4) to inform information regarding Tracking Area in which the UE 30 is located, the Cell the UE 30 belongs to, and the entry of the UE 30 to a specific region.

Note that an example of the UE 30 in FIG. 9 is the terminal device 30 of the present embodiment. An example of the RAN/AN 430 is the base station 20 of the present embodiment. Furthermore, the management device 10 illustrated in FIG. 5 is an example of a device having a function of the AF 449 or the AMF 441, for example.

### <3-2. Configuration Example of 4G Network Architecture>

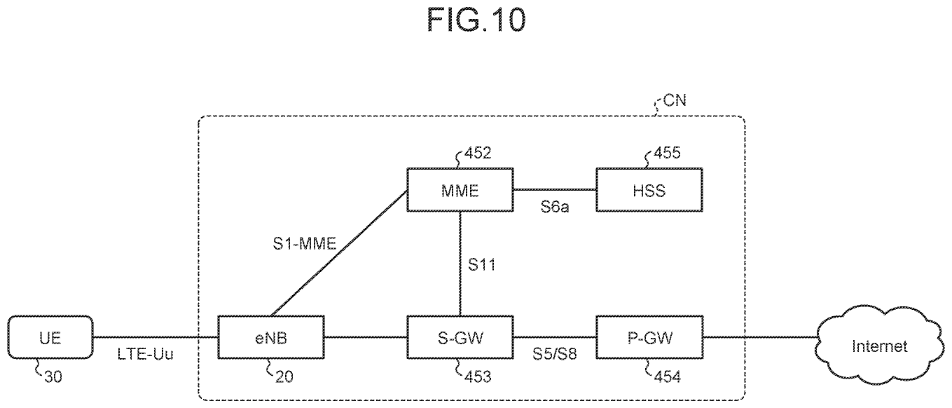

With reference to FIG. 10, an architecture of a fourth generation mobile communication system (4G) will be described as an example of the core network CN of the communication system 1. FIG. 10 is a diagram illustrating an example of a 4G architecture. Although the core network CN illustrated in FIG. 10 does not include the RAMNF, the core network CN may include the RAMNF as one of the network functions. Needless to say, the network function may be a network function disposed outside the RAMNF core network CN.

As illustrated in FIG. 10, the core network CN includes an eNB 20, a Mobility Management Entity (MME) 452, a Serving Gateway (S-GW) 453, a Packet Data Network Gateway (P-GW) 454, and a Home Subscriber Server (HSS) 455.

The eNB 20 functions as a 4G base station. The MME 452 is a control node that handles signals of a control plane and manages a movement state of UE 401. The UE 401 transmits an Attach request to the MME 452 in order to attach to the cellular system.

The S-GW 453 is a control node that handles user plane signals, and is a gateway device that switches a forwarding path of user data. The P-GW 454 is a control node that handles user plane signals, and is a gateway device to be a connection point between the core network CN and the Internet. HSS 455 is a control node that handles subscriber data and performs service control.

The MME 452 corresponds to the functions of the AMF 441 and the SMF 442 in the 5G network. In addition, the HSS 455 corresponds to the function of the UDM 448.

As illustrated in FIG. 3, the eNB 20 is connected to the MME 452 via an S1-MME interface, and is connected to the S-GW 453 via an S1-U interface. The S-GW 453 is connected to the MME 452 via an S11 interface, and the MME 452 is connected to the HSS 455 via an S6a interface. The P-GW 454 is connected to the S-GW 453 via an S5/S8 interface.

### <<4. Basic Operation of Communication System 1>>

Next, a basic operation of the communication system 1 of the present embodiment will be described.

A private network, having a property of being resistant to a security threat, is a network for a limited location, and thus, needs to expand the location. Accordingly, the present embodiment combines a plurality of private networks by the following method, thereby expanding the closed network while maintaining the properties of being highly resistant against security threats.

### <4-1. Method of Linking Private Networks>

In the present embodiment, in order to limit the communication range, the communication system 1 links two private networks as a pair (1:1). To implement 1:N (N private networks) communication, the communication system 1 creates N pairs of 1:1 private networks. In the case of an N:M network, the system creates M 1:1 private networks, and creates N sets of the M 1:1 private networks. Note that the network to be created as a pair of private networks (1:1).

This paring is performed to limit the communication range so as to prevent unlimited spreading in the forwarding of the IP address and ID of the terminal device 30. In addition, making the pairs only when necessary will suppress spreading of the closed network when unnecessary.

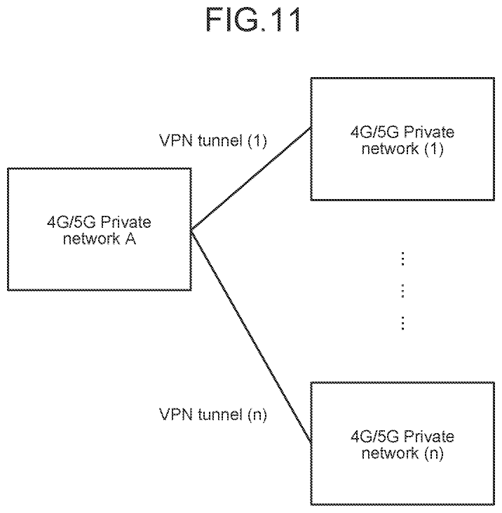

FIG. 11 is a diagram illustrating a state in which a plurality of 4G/5G private networks are linked with each other. As illustrated in FIG. 11, the two private networks are connected by a virtual private network (VPN). In the case of FIG. 11, the 4G/5G private network (1) and the 4G/5G private network (n) cannot communicate with each other. Note that the communication system 1 preliminarily sets a routing table to suppress the delivery of packets via the 4G/5G private network. This will suppress unlimited spreading in the forwarding of IP address or ID of the terminal device 30.

### <4-2. Procedure of Creating a Pair of Private Networks>

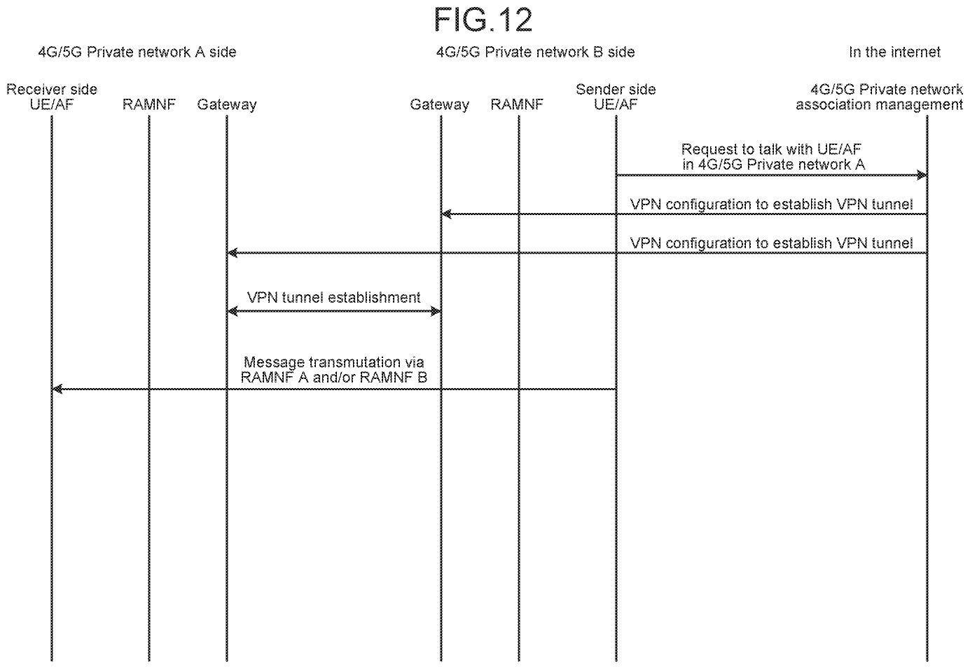

Next, a procedure of creating a pair of 4G/5G private networks will be described. FIG. 12 is a sequence diagram illustrating a procedure of creating a pair of 4G/5G private networks. In FIG. 12, the UE is the terminal device 30. In addition, the RAMNF, the AF, and the gateway are functions of the management device 10. Hereinafter, a procedure of creating a pair of 4G/5G private networks will be described with reference to FIG. 12.

### (1) Step 1

The client application (for example, the sender side UE/AF) transmits a request to 4G/5G private network association management to communicate between 4G/5G private network A and 4G/5G private network B. The request at this time may be transmitted using normal Internet. The 4G/5G private network association management is a function for connecting two private networks. This function is desirably arranged at a location accessible to gateways of a plurality of private networks such as on the Internet, for example, rather than being arranged in a closed network. This is because the function has a role of controlling the establishment of a VPN tunnel between the two private networks in accordance with the request. In the following description, 4G/5G private network association management may be referred to as an association manager.

### (2) Step 2

The association manager configures a VPN tunnel between 4G/5G private network A and 4G/5G private network B. Each 4G/5G private network is provided with one RAMNF. Each RAMNF provides the following functions for UE in the 4G/5G private network to which it belongs.
Name Resolution
Push notification
Providing information regarding state of terminal device

“Name resolution” is a function of returning an IP address of the terminal device 30 as a response to an inquiry about the IP address of the terminal device 30 with the ID of the terminal device 30. Name resolution is generally the same as a function of the Domain Name System (DNS).

“Push notification” is a function used as follows. When a message addressed to the terminal device 30 has been received together with the ID of the terminal device 30 from a client application, a packet including the message is transmitted to the terminal by using the IP address addressed to the terminal.

“Providing information regarding state of terminal device” is a function of notifying the client application whether the terminal device 30 is in the Idle mode or the Connected mode.

### (3) Step 3

After the pair is established, the client application performs name resolution on RAMNF in 4G/5G private network A or B by using the ID or the IP address of the terminal device 30 as a destination, acquires the IP address, and transmits the message to the destination terminal. Alternatively, the client application transmits the message to the destination terminal by using the push notification function.

### <4-3. ID for Specifying Communication Counterpart>

In the name resolution described above, the private network management identifies the IP address of the terminal device 30 with ID of the terminal device 30. Hereinafter, ID of the terminal device 30 will be described.

Usually, ID of the terminal device 30 is determined by using a Fully Qualified Domain Name (FQDN) or the like, but in the present embodiment, ID may be determined by using UE numbers such as 1 or 2. The number may be a sequence of the UE described in a subscriber file of the core network. The following table is an example of a subscriber file.

TABLE 1

| UE ID | SUPI (IMSI) |
|---|---|
| 1 | xxxxxxxxxxxxxxxxAAA |
| 2 | xxxxxxxxxxxxxxxxBBB |
| 3 | xxxxxxxxxxxxxxxxCCC |
| 4 | xxxxxxxxxxxxxxxxDDD |
| 5 | xxxxxxxxxxxxxxxxEEE |

In the subscriber file, subscription permanent identifier (SUPI) or International Mobile Subscriber Identity (IMSI) is allocated to each UE. The SUPI or the IMSI is ID for specifying the terminal, and the SUPI or the IMSI may be used in place of ID. However, SUPI and IMSI are unchangeable, and thus, have security risks such as abuse. In view of this, it is undesirable to forward the SUPI or IMSI as the ID of the terminal device 30 (UE). It is desirable to use the UE ID or FQDN in the left column.

In the present embodiment, ID of the terminal device 30 (UE) may be referred to as terminal ID.

### <<5. Detailed Operation of Communication System>>

The basic operation of the communication system 1 has been described above. Now, the operation of the communication system 1 will be described in detail below.

As described above, the conceivable methods of transmitting a packet between two 4G/5G private networks include: Method 1 of holding the IP address of the terminal device 30 on the receiver side only in the RAMNF of the receiver side private network; and Method 2 of holding the IP address of the terminal device 30 of the private network on the receiver side also in the RAMNF of the sender side private network.

Here, the receiver side private network is a 4G/5G private network connected to the terminal device 30 that receives the packet, while the sender side private network is a 4G/5G private network connected to the terminal device 30 that receives the packet.

In the following description, the terminal device 30 that transmits a packet may be referred to as sender side UE, and the terminal device 30 that receives a packet may be referred to as receiver side UE. Furthermore, although the following description assumes transmission of a packet between the terminal devices 30, application of the present embodiment is not limited to transmission of a packet between the terminal devices 30 as long as the packet is transmitted between private networks. For example, the present embodiment is also applicable to packet transmission from the sender side UE to the AF of the receiver side core network, packet transmission from the AF of the sender side core network to the receiver side UE, or packet transmission from the AF of the sender side core network to the AF of the receiver side core network.

Method 1 and Method 2 will be individually described in detail below.

### <5-1. Method 1>

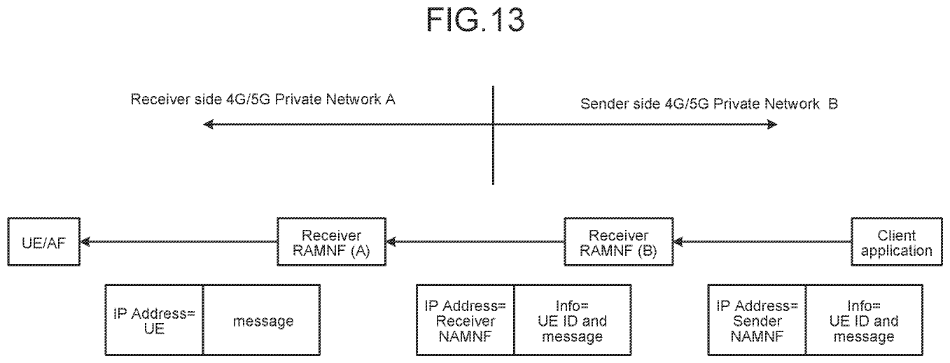

In Method 1, the RAMNF of the receiver side private network pushes a message to the receiver side UE without allowing the IP address of the receiver side UE acquired by the RAMNF of the receiver side private network to go outside the receiver side private network. As Method 1, Method 1-1 illustrated in FIG. 13 is conceivable.

FIG. 13 is a diagram illustrating Method 1-1. In the example of FIG. 13, 4G/5G private network A is a receiver side private network, while 4G/5G private network B is a sender side private network. Furthermore, RAMNF (A) is a RAMNF of a receiver side private network, while RAMNF (B) is a RAMNF of a sender side private network. In the following description, the UE or AF ID may be referred to as terminal ID.

In Method 1-1, RAMNF (A) first acquires the IP address of the receiver side UE. RAMNF (A) holds, in the storage device, the IP address of the receiver side UE together with the terminal ID of the receiver side UE in a pair. RAMNF (A) acquires the IP address of the terminal directly from the core network by using a Service Based Interface (SBI) of the core network.

When RAMNF (B) has received the terminal ID and the message of the receiver side UE from the client application mounted on the UE, RAMNF (B) determines which pair of 4G/5G private networks is currently in communication based on the terminal ID. Once the corresponding 4G/5G private network is determined, RAMNF (B) sends a message with the terminal ID of the receiver side UE to the IP address of RAMNF (A) of the determined 4G/5G private network. When RAMNF (A) has received a packet storing the terminal ID and the message, RAMNF (A) specifies the IP address of the receiver side UE based on the terminal ID stored in the packet, and sends the message to the IP address.

In Method 1-1, the client application only needs to send a message together with the terminal ID to the RAMNF in the 4G/5G private network to which the client application belongs, making it possible to simplify the operation of the client application. Instead, RAMNF (B) needs to know to which RAMNF (A) the message and the destination terminal ID are to be forwarded for each terminal ID. Regarding this information, when the two 4G/5G private networks are paired, it is necessary to pass information of the range of the terminal ID of each 4G/5G private network and the IP address of RAMNF (A) to RAMNF (B) on the counterpart side. The information exchange between RAMNF (A) and RAMNF (B) is one of features of the present method. RAMNF (A) and RAMNF (B) have a function like push notification. In the case of the conventional push notification, the destination terminal needs to keep the TCP connection to the RAMNF. However, in this method, the UE does not need to establish the TCP connection in advance. Furthermore, the client application can perform communication with the knowledge of the terminal ID along, leading to the reduction of the burden on the client.

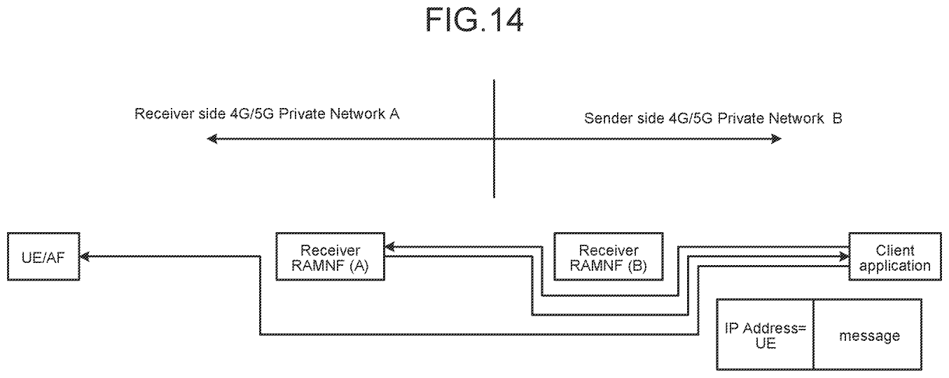

As illustrated in FIG. 14, it is conceivable to use a method in which RAMNF (A) performs name resolution. FIG. 14 is a diagram illustrating Method 1-2. Method 1-2, however, has increased latency compared to Method 1-1, and thus, Method 1-1 is more desirable.

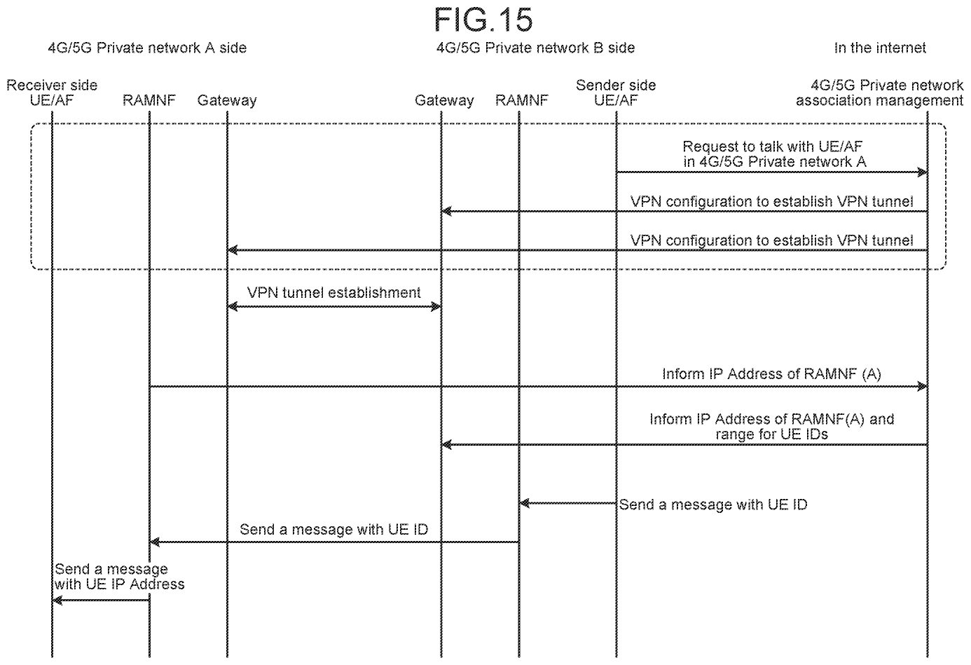

FIG. 15 is a sequence diagram illustrating a procedure of Method 1-1. In the drawing, a procedure in a part surrounded by a broken line is used to establish a VPN tunnel between 4G/5G private network A and 4G/5G private network B. The procedure of this part is the same as the procedure described with reference to FIG. 12.

In the example of FIG. 15, the address of RAMNF (A) is apparently conveyed to the association manager immediately after the establishment of the VPN tunnel. However, in order to inform the association manager of own IP address, RAMNF (A) may periodically prepare to establish a TCP connection with the association manager before establishment of the tunnel.

Another conceivable method would be a method in which RAMNF (A) transmits the IP address of RAMNF (A) to RAMNF (B) after the VPN tunnel is established. However, since RAMNF (A) has no prior knowledge of the IP address of RAMNF (B), this is considered undesirable. It may be desirable to grasp the IP addresses of each other via the association manager.

According to the present method, the acquired IP address of the UE is not taken out from the 4G/5G private network used for acquisition, making it possible to enhance the security.

### <5-2. Method 2>

In Method 2, the IP address of the receiver side UE acquired by the RAMNF of the receiver private network is forwarded to the RAMNF of the sender side private network. Subsequently, the RAMNF of the sender side private network performs pushing of the message to the receiver side UE.

In Method 1 described above, since the IP address of the receiver side UE remains within the receiver private network, Method 1 is desirable from the viewpoint of security. On the other hand, processing is required in two RAMNFs on the sender side and the receiver side, having a concern of increased latency. Method 2 improves these drawbacks of Method 1.

Method 2 includes Method 2-1 in which the RAMNF of the sender side private network performs push notification and Method 2-2 in which the sender side UE performs push notification. First, Method 2-1 will be described.

### <5-2-1. Method 2-1>

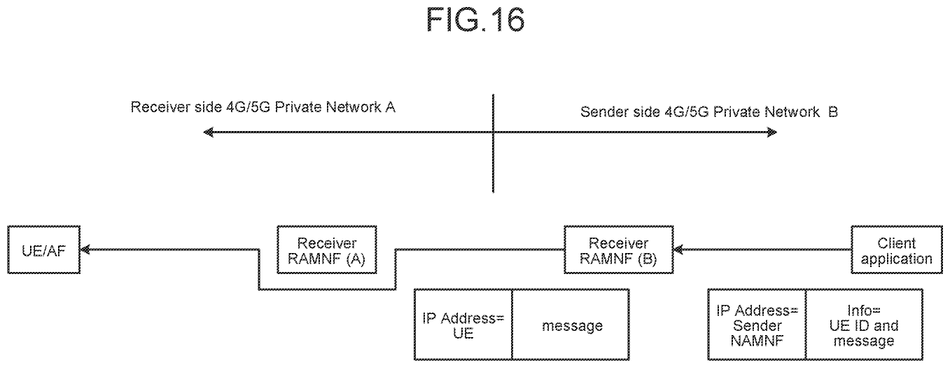

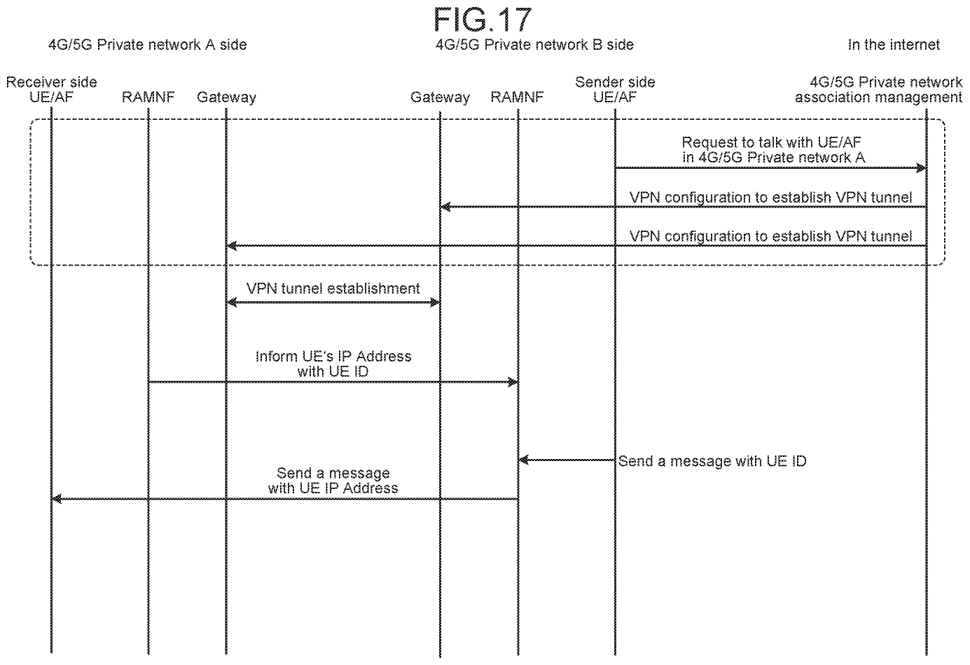

FIG. 16 is a diagram illustrating Method 2-1. FIG. 17 is a sequence diagram illustrating a procedure of Method 2-1. In the examples of FIGS. 16 and 17, 4G/5G private network A is a receiver side private network, and 4G/5G private network B is a sender side private network. Furthermore, RAMNF (A) is a RAMNF of a receiver side private network, while RAMNF (B) is a RAMNF of a sender side private network. In the following description, the UE or AF ID may be referred to as terminal ID.

In Method 2-1, RAMNF (A) first acquires the IP address of the receiver side UE. RAMNF (A) holds, in the storage device, the IP address of the receiver side UE together with the terminal ID of the receiver side UE in a pair. RAMNF (A) acquires the IP address of the terminal directly from the core network by using a Service Based Interface (SBI) of the core network.

After completion of pairing of 4G/5G private network A and 4G/5G private network B, RAMNF (A) notifies RAMNF (B) of the information of the IP address of the receiver side UE together with the terminal ID.

When a packet is transmitted from the client application of the sender side UE, RAMNF (B) replaces the destination of the packet with the IP address of the receiver side UE. Subsequently, RAMNF (B) transmits the packet with new destination to the receiver side UE. For example, the RAMNF (B) performs push notification based on a User Datagram Protocol (UDP) to the receiver side UE.

After cancellation of the pairing between 4G/5G private network A and 4G/5G private network B, the RAMNFs quickly discard information obtained from the RAMNF on the counterpart side (for example, information of the IP address of the terminal belonging to the 4G/5G private network on the counterpart side).

According to Method 2-1, there is one RAMNF related to packet transmission, leading to reduced latency.

### <5-2-2. Method 2-2>

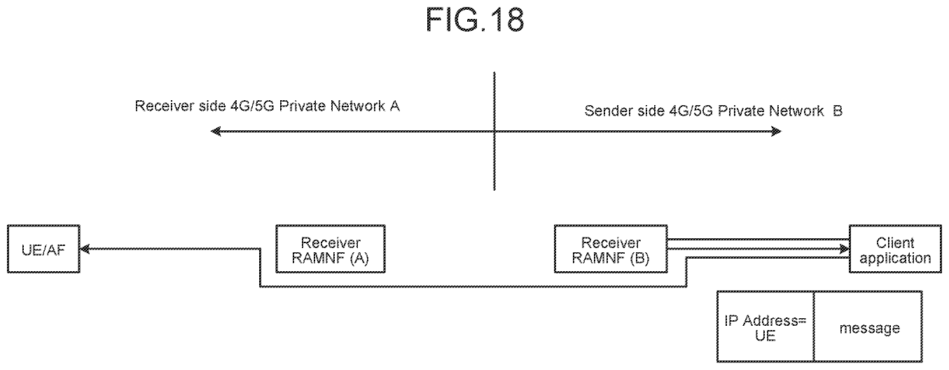

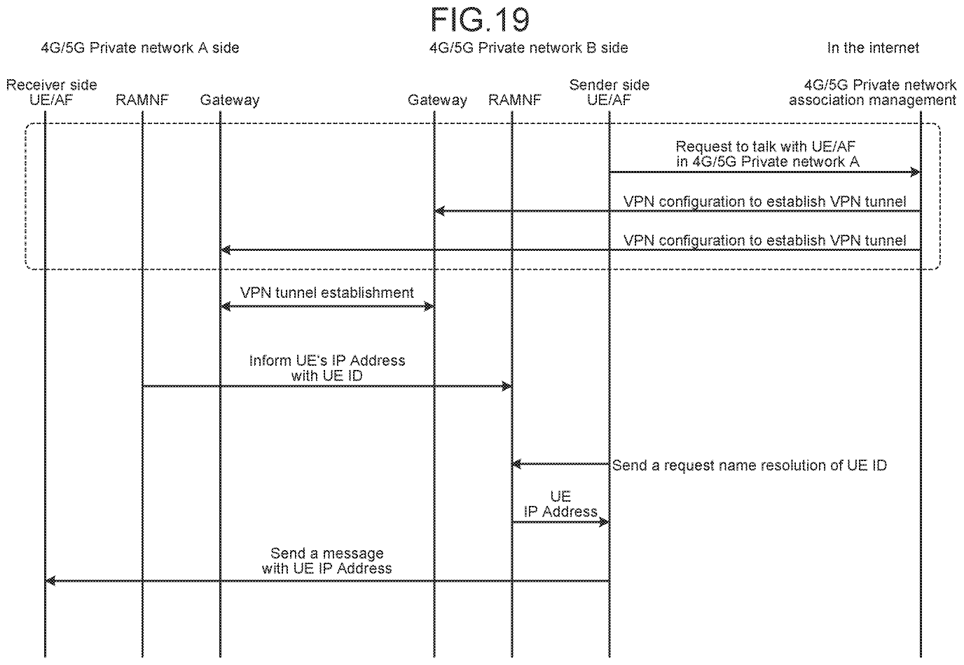

FIG. 18 is a diagram illustrating Method 2-2. FIG. 19 is a sequence diagram illustrating a procedure of Method 2-2. In the examples of FIGS. 18 and 19, 4G/5G private network A is a receiver side private network, while 4G/5G private network B is a sender side private network. Furthermore, RAMNF (A) is a RAMNF of a receiver side private network, while RAMNF (B) is a RAMNF of a sender side private network. In the following description, the UE or AF ID may be referred to as terminal ID.

In Method 2-2, RAMNF (A) first acquires the IP address of the receiver side UE. RAMNF (A) holds, in the storage device, the IP address of the receiver side UE together with the terminal ID of the receiver side UE in a pair. RAMNF (A) acquires the IP address of the terminal directly from the core network by using a Service Based Interface (SBI) of the core network.

After completion of pairing of 4G/5G private network A and 4G/5G private network B, RAMNF (A) notifies RAMNF (B) of the information of the IP address of the receiver side UE together with the terminal ID.

When having received a request for the IP address of the receiver side UE with the terminal ID of the receiver side UE from the client application of the sender side UE, RAMNF (B) returns the IP address of the receiver side UE to the client application. When having received the IP address of the receiver side UE, the client application transmits a packet to the IP address received. For example, the client application performs push notification based on a User Datagram Protocol (UDP) to the receiver side UE.

After cancellation of the pairing between 4G/5G private network A and 4G/5G private network B, the RAMNFs quickly discard information obtained from the RAMNF on the counterpart side (for example, information of the IP address of the terminal belonging to the 4G/5G private network on the counterpart side).

According to Method 2-2, the client application can directly communicate with a counterpart terminal, making it possible to reduce the latency. The direct communication is possible between the client application and the counterpart terminal not only in the case of TCP communication but also in UDP communication, leading to low latency.

### <<6. Other Operations of Communication System 1>>

The communication system 1 may also operate as follows.

### <6-1. Method 3>

Method 3 also forwards the IP address of the receiver side UE acquired by the RAMNF of the receiver side private network to the RAMNF of the sender side private network. At this time, depending on the state of the receiver side UE, the RAMNF of the sender side private network may suppress forwarding of the information of the state of the receiver side UE such as Idle/Connected to the RAMNF of the sender side private network.

The RAMNF has three functions related to information of UE in a private network to which the RAMNF belongs. The three functions are “name resolution”, “push notification”, and “provision of state information of terminal device”. The state of terminal device in the “provision of state of terminal device” represents states such as whether the terminal device 30 has acquired the IP address, and which of the Idle mode and the Connected mode the terminal device 30 is in. The key of the present method is which information, among these pieces of information, is to be transmitted from RAMNF (A) to RAMNF (B)/sender side UE.

The following table is a table illustrating an example of states of the terminal device.

TABLE 2

| Status | Description | Update Frequency |
|---|---|---|
| Registration | Whether IP Address has been | Low |
| | acquired or not | |
| RRC status | Whether terminal is in Idle | High |
| | mode or connected mode | |

The RRC status has a high update frequency. Therefore, forwarding RRC status information from RAMNF (A) to RAMNF (B) would cause a problem of an increase in network traffic. On the other hand, since the registration mainly changes with power on/off, the registration information is updated less frequently. In addition, in order to avoid a state of loss of the IP address of the receiver side UE in practice when the client application attempts to acquire the IP address from RAMNF (B), RAMNF (A) should transmit the latest registration information to RAMNF (B) at appropriate timings.

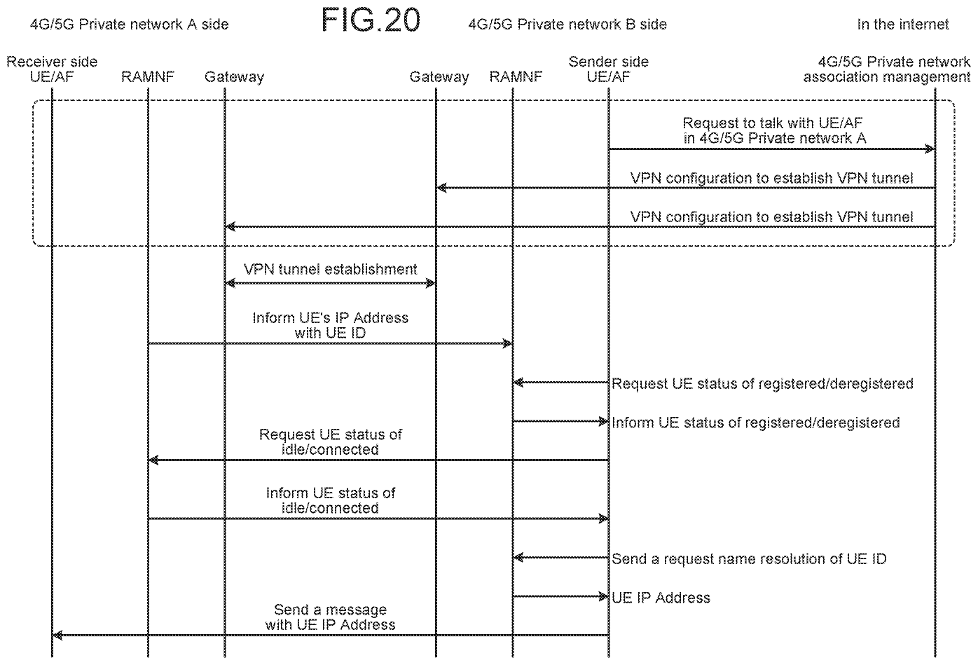

FIG. 20 is a sequence diagram in which the procedure of Method 3 is added to the procedure of Method 2-2 as a base. The procedure of Method 3 will be described below with reference to FIG. 20.

First, before sending the message, the client application sends an inquiry to RAMNF (B) as to whether the receiver side UE has acquired an IP address (that is, whether the receiver side UE is in a registered state).

When the receiver side UE has already acquired the IP address, the client application sends an inquiry to RAMNF (A) as to whether the receiver side UE is in the Connected mode or the Idle mode. The client application transmits a message to the receiver side UE only when the receiver side UE is Connected. This is because the power consumption of the receiver side UE can be suppressed by sending the message only at the time of Connected. In addition, the reason why the inquiry destination is RAMNF (A) is that the state of Idle/Connected changes frequently.

The client application that determines transmission of a message sends an inquiry to RAMNF (B) for the IP address of the receiver side UE by using the terminal ID of the receiver side UE. After acquiring the IP address, the client application transmits a message to the receiver side UE by using the IP packet to which the IP address is assigned.

When RAMNF (B) has received a message from the client application and transmits the message to the receiver side UE, RAMNF (B) may send an inquiry to RAMNF (A) as to whether the receiver side UE is in the Connected mode or the Idle mode. The client application may transmit the message to the receiver side UE only when the receiver side UE is Connected.

According to Method 3, it is possible to minimize the forwarding of information of the UE state. This leads to achievement of reduction of security threats of revealing UE state information to competitors.

### <6-2. Method 4>

In Method 4, when RAMNF (A) indicates a plan of the Idle mode/Connected mode of the counterpart terminal, the communication device of 4G/5G private network A allows the transmission of the packet from 4G/5G private network B to the UE of 4G/5G private network A only in the limited period associated with the section of the Connected mode. When the packet arrives during other periods, the communication device discards the packet.

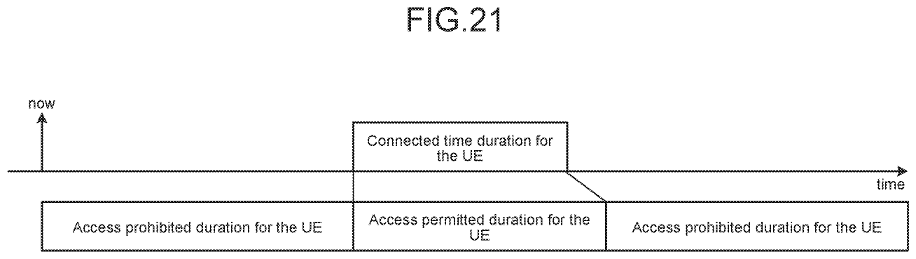

FIG. 21 is a diagram illustrating a period in which packet transmission is permitted. A certain API of 5G Access Management Function (AMF) can transition the UE from the Idle mode to the Connected mode. Using this API makes it possible to set the UE in the Connected mode at a specific time. The use of this API makes it possible to set a specific UE to the Connected mode in a specific section based as scheduled.

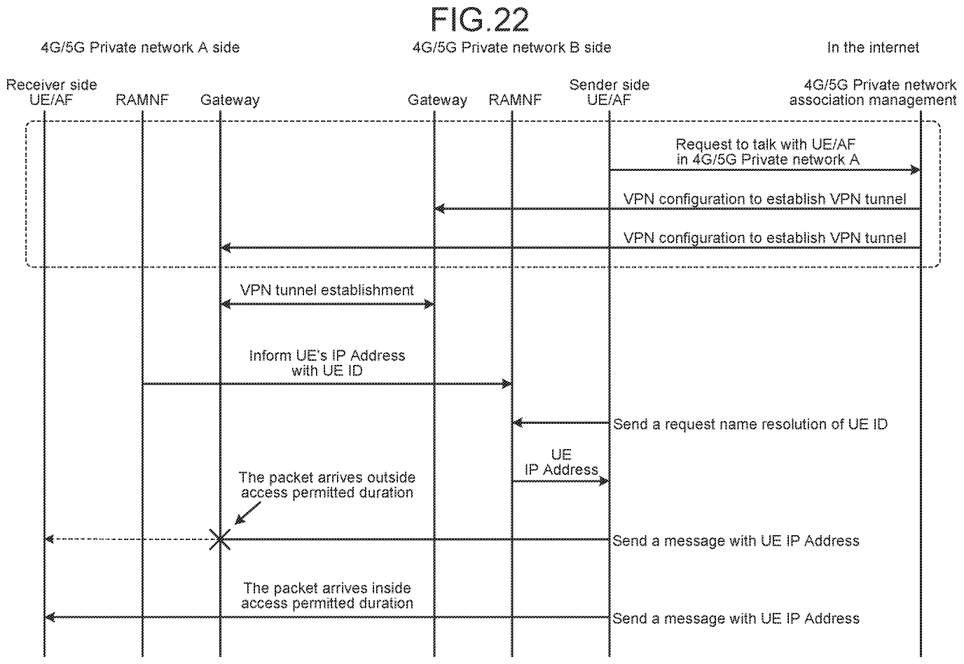

FIG. 22 is a sequence diagram illustrating a procedure of Method 4. RAMNF (A) transmits, to RAMNF (B), the terminal ID of the receiver side UE and information regarding a time section (a time during which the terminal is in the Connected mode) in which the UE is accessible.

When having received a packet from the client application on the RAMNF (B) side, the communication device of 4G/5G private network A accepts all the packets when the received packet is a packet addressed to RAMNF (A). In the case of a packet of another destination, the communication device accepts the packet in a time section in which the receiver side UE can access, and discards the packet in the case of other time sections. This processing may be implemented by RAMNF (A) checking all the packets from the gateway of 4G/5G private network A. Note that the accessible time section may be linked with a section in which the terminal is scheduled to be in the Connected mode.

According to Method 4, it is possible to reject a packet arriving at a time other than the time disclosed in advance, enabling enhanced resistance to attack from a malicious client application.

### <6-3. Method 1-3>

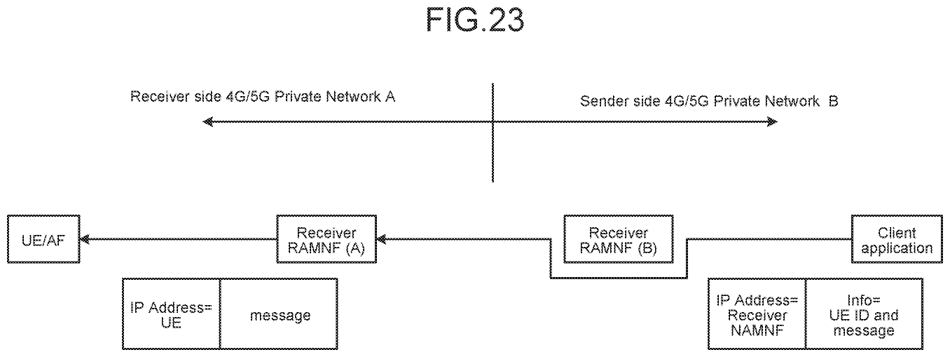

In <5-1. Method 1> described above, Method 1-1 and Method 1-2 are exemplified as Method 1. However, Method 1 can also include Method 1-3 illustrated in FIG. 23 as a conceivable method.

FIG. 23 is a diagram illustrating Method 1-3. In the example of FIG. 23, 4G/5G private network A is a receiver side private network, while 4G/5G private network B is a sender side private network. Furthermore, RAMNF (A) is a RAMNF of a receiver side private network, while RAMNF (B) is a RAMNF of a sender side private network. In the following description, the UE or AF ID may be referred to as terminal ID.

In Method 1-3, the sending side UE need to hold information for determining to which RAMNF a message is to be sent for each terminal ID of the receiver side UE in advance. The client application of the sender side UE transmits a packet storing the terminal ID of the receiver side UE and a message to the receiver side UE to RAMNF (A) specified based on the information.

When having received a packet from the client application, RAMNF (A) determines to which UE the communication is to be performed based on the terminal ID stored in the packet. Subsequently, RAMNF (A) transmits a packet to the specified UE.

In the case of Method 1-3, the sender side UE needs to manage the IP addresses of the plurality of RAMNFs. Still, since the IP address of the terminal device is held only in the RAMNF on the terminal device side, security threats are relatively small.

### 7. MODIFICATION

The above-described embodiment is an example, and various modifications and applications are possible.

For example, in the above-described embodiment, two 4G/5G private networks connected by the VPN tunnel are described as an example of “two non-public cellular closed networks connected to each other by secure communication”. However, the “two non-public cellular closed networks connected to each other by secure communication” is not limited thereto, and may be two 4G/5G private networks connected by cryptographic communication, for example.

The control device that controls the management device 10, the base station 20, and the terminal device 30 of the present embodiment may be actualized by a dedicated computer system or a general-purpose computer system.

For example, a communication program for executing the above-described operations is stored in a computer-readable recording medium such as an optical disk, semiconductor memory, a magnetic tape, or a flexible disk and distributed. For example, the program is installed on a computer and the above processing is executed to achieve the configuration of the control device. At this time, the control device may be devices (for example, a personal computer) external to the management device 10, the base station 20, or the terminal device 30. Furthermore, the control device may be a device (for example, the control unit 13, the control unit 23, and the control unit 33) inside the management device 10, the base station 20, and the terminal device 30, respectively.

Furthermore, the communication program may be stored in a disk device included in a server device on a network such as the Internet so as to be able to be downloaded to a computer, for example. Furthermore, the functions described above may be implemented by using operating system (OS) and application software in cooperation. In this case, the portions other than the OS may be stored in a medium for distribution, or the portions other than the OS may be stored in a server device so as to be downloaded to a computer, for example.

Furthermore, among individual processing described in the above embodiments, all or a part of the processing described as being performed automatically may be manually performed, or the processing described as being performed manually can be performed automatically by known methods. In addition, the processing procedures, specific names, and information including various data and parameters illustrated in the above Literatures or drawings can be arbitrarily altered unless otherwise specified. For example, a variety of information illustrated in each of the drawings are not limited to the information illustrated.

In addition, each of components of each device is provided as a functional and conceptional illustration and thus does not necessarily need to be physically configured as illustrated. That is, the specific form of distribution/integration of each of the devices is not limited to those illustrated in the drawings, and all or a part thereof may be functionally or physically distributed or integrated into arbitrary units according to various loads and use situations. This configuration by distribution and integration may be performed dynamically.

Furthermore, the above-described embodiments can be appropriately combined within a range implementable without contradiction of processing. Furthermore, the order of individual steps illustrated in the flowcharts of the above-described embodiment can be changed as appropriate.

Furthermore, for example, the present embodiment can be implemented as any configuration constituting a device or a system, for example, a processor as a large scale integration (LSI) or the like, a module using a plurality of processors or the like, a unit using a plurality of modules or the like, and a set obtained by further adding other functions to the unit, or the like (that is, a configuration of a part of the device).

In the present embodiment, a system represents a set of a plurality of components (devices, modules (parts), or the like), and whether all the components are in the same housing would not be a big issue. Therefore, a plurality of devices housed in separate housings and connected via a network, and one device in which a plurality of modules are housed in one housing, are both systems.

Furthermore, for example, the present embodiment can adopt a configuration of cloud computing in which one function is cooperatively shared and processed by a plurality of devices via a network.

### 8. CONCLUSION

As described above, the information processing device (for example, the management device 10) of the present embodiment is an information processing device having at least one network function among the network functions (for example, RAMNFs) disposed individually in two non-public cellular closed networks connected to each other by secure communication. The network function acquires information (for example, terminal ID and/or IP address) related to a communication device connected to the non-public cellular closed network on the own side or the counterpart side, and perform, based on the acquired information, processing related to packet arrival from the communication device (for example, the sender side UE) connected to one of the two non-public cellular closed networks to the communication device (for example, receiver side UE) connected to the other of the two non-public cellular closed networks. This makes it possible to implement communication with high security strength between two non-public cellular closed networks.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

The effects described in the present specification are merely examples, and thus, there may be other effects, not limited to the exemplified effects.

Note that the present technique can also have the following configurations.

(1)

An information processing device comprising at least one network function among network functions disposed in each of two non-public cellular closed networks connected to each other by secure communication,
wherein the network function
acquires information related to a communication device connected to the non-public cellular closed network of an own side or a counterpart side, and
perform, based on the acquired information, processing related to packet arrival from the communication device connected to one of the two non-public cellular closed networks to the communication device connected to the other of the two non-public cellular closed networks.
   (2)

The information processing device according to (1),
wherein the network function
acquires information related to the communication device connected to the non-public cellular closed network on the own side, and
notifies the network function in the non-public cellular closed network on the counterpart side of the acquired information.
   (3)

The information processing device according to (2),
wherein the network function
acquires an IP address of the communication device connected to the non-public cellular closed network on the own side and terminal ID of a communication device corresponding to the IP address, and
notifies the network function in the non-public cellular closed network on the counterpart side of the IP address of the communication device connected to the non-public cellular closed network of the own side together with the terminal ID of the communication device corresponding to the IP address.
   (4)

The information processing device according to (2),
wherein the network function
acquires an IP address of the communication device connected to the non-public cellular closed network on the own side and terminal ID of a communication device corresponding to the IP address, and
notifies the network function in the non-public cellular closed network on the counterpart side of terminal ID of the communication device corresponding to the IP address together with the IP address of the network function itself without notifying the IP address of the communication device connected to the non-public cellular closed network on the own side.
   (5)

The information processing device according to (2),
wherein the network function
acquires, from a core network of the non-public cellular closed network on the own side, information related to a state of the communication device connected to the non-public cellular closed network on the own side, and
notifies the network function of the non-public cellular closed network on the counterpart side of the acquired information related to the state of the communication device.
   (6)

The information processing device according to (5),
wherein the information related to the state of the communication device includes information for specifying that the communication device is in a Connected mode.
   (7)

The information processing device according to (5) or (6),
wherein the information related to the state of the communication device includes registration information regarding the communication device, and does not include information regarding an RRC status of the communication device.
   (8)

The information processing device according to (1),
wherein the network function
acquires information related to the communication device connected to the non-public cellular closed network on the counterpart side, and
performs, based on the acquired information, processing related to packet arrival from the communication device connected to the non-public cellular closed network on the own side to the communication device connected to the non-public cellular closed network on the counterpart side.
   (9)

The information processing device according to (8),
wherein the network function
acquires an IP address of the communication device connected to the non-public cellular closed network of the counterpart side together with terminal ID of the communication device corresponding to the IP address from the network function of the non-public cellular closed network on the counterpart side, and
when transmission information has been acquired from the communication device connected to the non-public cellular closed network on the own side together with terminal ID of a communication device as a transmission destination of information, specifies an IP address of the communication device as the transmission destination based on the terminal ID, and transmits transmission information addressed to the specified IP address.
   (10)

The information processing device according to (9),
wherein the network function
performs push notification of the transmission information based on a User Datagram Protocol (UDP) to the communication device as the transmission destination.
   (11)

The information processing device according to (8),
wherein the network function
acquires an IP address of the communication device connected to the non-public cellular closed network of the counterpart side together with terminal ID of the communication device corresponding to the IP address from the network function of the non-public cellular closed network on the counterpart side, and
when information of terminal ID of a communication device as a transmission destination of information has been acquired from the communication device connected to the non-public cellular closed network on the own side, specifies an IP address of the communication device as the transmission destination based on the terminal ID and returns the specified IP address.
   (12)

The information processing device according to (8),
wherein the network function
acquires terminal ID of the communication device connected to the non-public cellular closed network on the counterpart side together with an IP address of the network function of the non-public cellular closed network on the counterpart side from the network function of the non-public cellular closed network on the counterpart side, and
when transmission information has been acquired together with terminal ID of a communication device as a transmission destination of information from the communication device connected to the non-public cellular closed network on the own side, specifies an IP address of a network function as a transmission destination based on the terminal ID, and transmits the transmission information together with the terminal ID addressed to the specified IP address.
   (13)

The information processing device according to (8),
wherein the network function
acquires information related to a state of the communication device connected to the non-public cellular closed network on a counterpart side from the network function of the non-public cellular closed network on the counterpart side, and
performs, based on the acquired information related to the state of the communication device, processing related to packet arrival from the communication device connected to the non-public cellular closed network on the own side to the communication device connected to the non-public cellular closed network on the counterpart side.
   (14)

The information processing device according to (13),
wherein the information related to the state of the communication device includes information for specifying that the communication device is in a Connected state, and
the network function
performs information transmission processing in a case where the state of the transmission destination communication device has been specified as the Connected state.
   (15)

The information processing device according to any one of (1) to (14),
wherein the two non-public cellular closed networks are directly connected to each other by a virtual private network (VPN).
   (16)

The information processing device according to any one of (1) to (15),
wherein the network function is disposed in a core network of the non-public cellular closed network.
   (17)

A communication device connected to one of two non-public cellular closed networks connected to each other by secure communication,
wherein each of the two non-public cellular closed networks is provided with a network function, the network function acquiring information related to the communication device connected to the non-public cellular closed network on an own side or on a counterpart side, and performing, based on the acquired information, processing related to packet arrival from the communication device connected to one of the two non-public cellular closed networks to the communication device connected to the other of the two non-public cellular closed networks, and
the communication device
acquires, from the network function, information related to the communication device connected to the non-public cellular closed network on the counterpart side, and
transmits, based on the acquired information, a packet to the communication device connected to the non-public cellular closed network on the counterpart side.
   (18)

An information processing method to be executed by an information processing device including at least one network function among network functions disposed in each of two non-public cellular closed networks connected to each other by secure communication, the information processing method comprising:
by the information processing device executing the network function,
acquiring information related to a communication device connected to the non-public cellular closed network of an own side or a counterpart side; and
performing, based on the acquired information, processing related to packet arrival from the communication device connected to one of the two non-public cellular closed networks to the communication device connected to the other of the two non-public cellular closed networks.
   (19)

A communication method to be executed by a communication device, the communication device being connected to one of two non-public cellular closed networks connected to each other by secure communication,
each of the two non-public cellular closed networks being provided with a network function, the network function acquiring information related to the communication device connected to the non-public cellular closed network on an own side or on a counterpart side, and performing, based on the acquired information, processing related to packet arrival from the communication device connected to one of the two non-public cellular closed networks to the communication device connected to the other of the two non-public cellular closed networks, the communication method comprising:
by the communication device,
acquiring, from the network function, information related to the communication device connected to the non-public cellular closed network on the counterpart side; and
transmitting, based on the acquired information, a packet to the communication device connected to the non-public cellular closed network on the counterpart side.
   (20)

A communication system comprising: an information processing device including at least one network function among network functions disposed in each of two non-public cellular closed networks connected to each other by secure communication; and a communication device connected to one of the two non-public cellular closed networks,
wherein the network function
acquires information related to the communication device connected to the non-public cellular closed network on an own side or on a counterpart side, and
performs, based on the acquired information, processing related to packet arrival from the communication device connected to one of the two non-public cellular closed networks to the communication device connected to the other of the two non-public cellular closed networks, and
the communication device
acquires, from the network function, information related to the communication device connected to the non-public cellular closed network on the counterpart side, and
transmits, based on the acquired information, a packet to the communication device connected to the non-public cellular closed network on the counterpart side.

### REFERENCE SIGNS LIST

1 COMMUNICATION SYSTEM
10 MANAGEMENT DEVICE
20 BASE STATION
30 TERMINAL DEVICE
11 COMMUNICATION UNIT
21, 31 WIRELESS COMMUNICATION UNIT
12, 22, 32 STORAGE UNIT
13, 23, 33 CONTROL UNIT
211, 311 TRANSMISSION PROCESSING UNIT
212, 312 RECEPTION PROCESSING UNIT
213, 313 ANTENNA

1. An information processing device comprising at least one network function among network functions disposed in each of two non-public cellular closed networks connected to each other by secure communication,
wherein the network function
acquires information related to a communication device connected to the non-public cellular closed network of an own side or a counterpart side, and
perform, based on the acquired information, processing related to packet arrival from the communication device connected to one of the two non-public cellular closed networks to the communication device connected to the other of the two non-public cellular closed networks.

2. The information processing device according to claim 1,
wherein the network function
acquires information related to the communication device connected to the non-public cellular closed network on the own side, and
notifies the network function in the non-public cellular closed network on the counterpart side of the acquired information.

3. The information processing device according to claim 2,
wherein the network function
acquires an IP address of the communication device connected to the non-public cellular closed network on the own side and terminal ID of a communication device corresponding to the IP address, and
notifies the network function in the non-public cellular closed network on the counterpart side of the IP address of the communication device connected to the non-public cellular closed network of the own side together with the terminal ID of the communication device corresponding to the IP address.

4. The information processing device according to claim 2,
wherein the network function
acquires an IP address of the communication device connected to the non-public cellular closed network on the own side and terminal ID of a communication device corresponding to the IP address, and
notifies the network function in the non-public cellular closed network on the counterpart side of terminal ID of the communication device corresponding to the IP address together with the IP address of the network function itself without notifying the IP address of the communication device connected to the non-public cellular closed network on the own side.

5. The information processing device according to claim 2,
wherein the network function
acquires, from a core network of the non-public cellular closed network on the own side, information related to a state of the communication device connected to the non-public cellular closed network on the own side, and
notifies the network function of the non-public cellular closed network on the counterpart side of the acquired information related to the state of the communication device.

6. The information processing device according to claim 5,
wherein the information related to the state of the communication device includes information for specifying that the communication device is in a Connected mode.

7. The information processing device according to claim 5,
wherein the information related to the state of the communication device includes registration information regarding the communication device, and does not include information regarding an RRC status of the communication device.

8. The information processing device according to claim 1,
wherein the network function
acquires information related to the communication device connected to the non-public cellular closed network on the counterpart side, and
performs, based on the acquired information, processing related to packet arrival from the communication device connected to the non-public cellular closed network on the own side to the communication device connected to the non-public cellular closed network on the counterpart side.

9. The information processing device according to claim 8,
wherein the network function
acquires an IP address of the communication device connected to the non-public cellular closed network of the counterpart side together with terminal ID of the communication device corresponding to the IP address from the network function of the non-public cellular closed network on the counterpart side, and
when transmission information has been acquired from the communication device connected to the non-public cellular closed network on the own side together with terminal ID of a communication device as a transmission destination of information, specifies an IP address of the communication device as the transmission destination based on the terminal ID, and transmits transmission information addressed to the specified IP address.

10. The information processing device according to claim 9,
wherein the network function
performs push notification of the transmission information based on a User Datagram Protocol (UDP) to the communication device as the transmission destination.

11. The information processing device according to claim 8,
wherein the network function
acquires an IP address of the communication device connected to the non-public cellular closed network of the counterpart side together with terminal ID of the communication device corresponding to the IP address from the network function of the non-public cellular closed network on the counterpart side, and
when information of terminal ID of a communication device as a transmission destination of information has been acquired from the communication device connected to the non-public cellular closed network on the own side, specifies an IP address of the communication device as the transmission destination based on the terminal ID and returns the specified IP address.

12. The information processing device according to claim 8,
wherein the network function
acquires terminal ID of the communication device connected to the non-public cellular closed network on the counterpart side together with an IP address of the network function of the non-public cellular closed network on the counterpart side from the network function of the non-public cellular closed network on the counterpart side, and
when transmission information has been acquired together with terminal ID of a communication device as a transmission destination of information from the communication device connected to the non-public cellular closed network on the own side, specifies an IP address of a network function as a transmission destination based on the terminal ID, and transmits the transmission information together with the terminal ID addressed to the specified IP address.

13. The information processing device according to claim 8,
wherein the network function
acquires information related to a state of the communication device connected to the non-public cellular closed network on a counterpart side from the network function of the non-public cellular closed network on the counterpart side, and
performs, based on the acquired information related to the state of the communication device, processing related to packet arrival from the communication device connected to the non-public cellular closed network on the own side to the communication device connected to the non-public cellular closed network on the counterpart side.

14. The information processing device according to claim 13,
wherein the information related to the state of the communication device includes information for specifying that the communication device is in a Connected state, and
the network function
performs information transmission processing in a case where the state of the transmission destination communication device has been specified as the Connected state.

15. The information processing device according to claim 1,
wherein the two non-public cellular closed networks are directly connected to each other by a virtual private network (VPN).

16. The information processing device according to claim 1,
wherein the network function is disposed in a core network of the non-public cellular closed network.

17. A communication device connected to one of two non-public cellular closed networks connected to each other by secure communication,
wherein each of the two non-public cellular closed networks is provided with a network function, the network function acquiring information related to the communication device connected to the non-public cellular closed network on an own side or on a counterpart side, and performing, based on the acquired information, processing related to packet arrival from the communication device connected to one of the two non-public cellular closed networks to the communication device connected to the other of the two non-public cellular closed networks, and
the communication device
acquires, from the network function, information related to the communication device connected to the non-public cellular closed network on the counterpart side, and
transmits, based on the acquired information, a packet to the communication device connected to the non-public cellular closed network on the counterpart side.

18. An information processing method to be executed by an information processing device including at least one network function among network functions disposed in each of two non-public cellular closed networks connected to each other by secure communication, the information processing method comprising:
by the information processing device executing the network function,
acquiring information related to a communication device connected to the non-public cellular closed network of an own side or a counterpart side; and
performing, based on the acquired information, processing related to packet arrival from the communication device connected to one of the two non-public cellular closed networks to the communication device connected to the other of the two non-public cellular closed networks.

19. A communication method to be executed by a communication device, the communication device being connected to one of two non-public cellular closed networks connected to each other by secure communication,
each of the two non-public cellular closed networks being provided with a network function, the network function acquiring information related to the communication device connected to the non-public cellular closed network on an own side or on a counterpart side, and performing, based on the acquired information, processing related to packet arrival from the communication device connected to one of the two non-public cellular closed networks to the communication device connected to the other of the two non-public cellular closed networks, the communication method comprising:
by the communication device,
acquiring, from the network function, information related to the communication device connected to the non-public cellular closed network on the counterpart side; and
transmitting, based on the acquired information, a packet to the communication device connected to the non-public cellular closed network on the counterpart side.

20. A communication system comprising: an information processing device including at least one network function among network functions disposed in each of two non-public cellular closed networks connected to each other by secure communication; and a communication device connected to one of the two non-public cellular closed networks,
wherein the network function
acquires information related to the communication device connected to the non-public cellular closed network on an own side or on a counterpart side, and
performs, based on the acquired information, processing related to packet arrival from the communication device connected to one of the two non-public cellular closed networks to the communication device connected to the other of the two non-public cellular closed networks, and
the communication device
acquires, from the network function, information related to the communication device connected to the non-public cellular closed network on the counterpart side, and
transmits, based on the acquired information, a packet to the communication device connected to the non-public cellular closed network on the counterpart side.
